(19) United States
(12) Patent Application Publication
(10) Pub. No.: US 2018/0081474 A1
(43) Pub. Date: Mar. 22, 2018

(54) TOUCH DISPLAY DEVICES

(71) Applicant: InnoLux Corporation, Miao-Li County (TW)

(72) Inventors: Jui-Jen YUEH, Miao-Li County (TW); Hsiao-Lang LIN, Miao-Li County (TW); Chia-Hao TSAI, Miao-Li County (TW); Ming-Jou TAI, Miao-Li County (TW)

(21) Appl. No.: 15/697,698

(22) Filed: Sep. 7, 2017

(30) Foreign Application Priority Data
Sep. 21, 2016 (CN) 201610837550.8

(51) Int. Cl. G06F 3/041; G06F 3/044; G02F 1/1343; G06F 3/047; G02F 1/1333

(52) U.S. Cl. CPC G06F 3/0412; G06F 3/044; G06F 2203/04106; G06F 3/047; G02F 1/13338; G02F 1/1343

(57) ABSTRACT

A touch display device is provided. The touch display device includes a substrate including a display area and a non-display area, wherein the non-display area is adjacent to the display area; a conductive unit disposed on the substrate, wherein the conductive unit includes a first electrode and a wire; a first insulating layer disposed on the conductive unit, wherein the first insulating layer includes a first opening and a second opening; a light emitting layer disposed on the first electrode; and a second electrode disposed on the first insulating layer, wherein the second electrode electrically connects to the light emitting layer and the first electrode through the first opening and electrically connects to the wire through the second opening, wherein the wire extends from the display area to the non-display area and electrically connects to a signal source.

### CROSS REFERENCE TO RELATED APPLICATIONS

This application claims priority of China Patent Application No. 201610837550.8, filed on Sep. 21, 2016, the entirety of which is incorporated by reference herein.

### TECHNICAL FIELD

The technical field relates to self-capacitance and mutual-capacitance touch display devices.

### BACKGROUND

The organic light-emitting diode (OLED) is one of the mainstream of current display technology and are becoming increasingly popular in wearable, mobile, and automotive-related display applications. Depending on the purpose of the application, the touch function is necessary. At present, there are many problems with in-cell touch OLED technology in product development, such as materials, processes, or drive manners. Therefore, there is no suitable in-cell touch sensing technology for OLED displays.

Therefore, it is desirable to develop a competitive in-cell touch display device.

### SUMMARY

One embodiment of the disclosure provides a touch display device comprising a substrate comprising a display area and a non-display area, wherein the non-display area is adjacent to the display area; a conductive unit disposed on the substrate, wherein the conductive unit comprises a first electrode and a wire; a first insulating layer disposed on the conductive unit, wherein the first insulating layer comprises a first opening and a second opening; a light emitting layer disposed on the first electrode; and a second electrode disposed on the first insulating layer, wherein the second electrode electrically connects to the light emitting layer and the first electrode through the first opening and electrically connects to the wire through the second opening, wherein the wire extends from the display area to the non-display area and electrically connects to a signal source.

One embodiment of the disclosure provides a touch display device comprising a substrate; a first electrode disposed on the substrate; a first insulating layer disposed on the first electrode, wherein the first insulating layer comprises an opening; a light emitting layer disposed on the first electrode; a conductive unit disposed on the first insulating layer, wherein the conductive unit comprises a second electrode and a third electrode, wherein the second electrode electrically connects to the light emitting layer and the first electrode through the opening, and the second electrode is electrically isolated from the third electrode; a second insulating layer disposed on the conductive unit; a fourth electrode disposed on the second insulating layer; a first wire electrically connects to the second electrode or the third electrode; and a second wire electrically connects to the fourth electrode, wherein the second electrode or the third electrode electrically connects to a first signal source through the first wire, and the fourth electrode electrically connects to a second signal source through the second wire.

One embodiment of the disclosure provides a touch display device comprising a substrate; a first electrode disposed on the substrate; a first insulating layer disposed on the first electrode, wherein the first insulating layer comprises a first opening; a light emitting layer disposed on the first electrode; an isolation layer disposed on the first insulating layer, wherein the isolation layer comprises a first portion and a second portion, and the first portion is separated from the second portion; a conductive unit comprising a second electrode, a third electrode and a fourth electrode, wherein the second electrode is disposed on the first insulating layer, the third electrode is disposed on the first portion, and the fourth electrode is disposed on the second portion, wherein the second electrode electrically connects to the light emitting layer and the first electrode through the first opening; a first wire electrically connects to the second electrode or the third electrode; and a second wire electrically connects to the fourth electrode, wherein the second electrode or the third electrode electrically connects to a first signal source through the first wire, the fourth electrode electrically connects to a second signal source through the second wire.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1A is a top view of a touch display device in accordance with one embodiment of the disclosure;

FIG. 1B is a cross-sectional view of the touch display device taken along A-A′ line of FIG. 1A;

FIGS. 2A-2D are cross-sectional views of a method for fabricating a touch display device in accordance with one embodiment of the disclosure;

FIG. 3A is a top view of a touch display device in accordance with one embodiment of the disclosure;

FIG. 3B is a cross-sectional view of the touch display device taken along A-A′ line of FIG. 3A;

FIGS. 4A-4D are cross-sectional views of a method for fabricating a touch display device in accordance with one embodiment of the disclosure;

FIGS. 5A-5D are cross-sectional views of a variety of separated layers with double-layer structures in accordance with one embodiment of the disclosure;

FIG. 6A is a top view of a touch display device in accordance with one embodiment of the disclosure;

FIG. 6B is a cross-sectional view of the touch display device taken along A-A′ line of FIG. 6A;

FIGS. 7A-7E are cross-sectional views of a method for fabricating a touch display device in accordance with one embodiment of the disclosure;

FIG. 8A is a top view of a touch display device in accordance with one embodiment of the disclosure;

FIG. 8B is a cross-sectional view of the touch display device taken along A-A′ line of FIG. 8A;

FIGS. 9A-9E are cross-sectional views of a method for fabricating a touch display device in accordance with one embodiment of the disclosure;

FIG. 10A is a top view of a touch display device in accordance with one embodiment of the disclosure;

FIG. 10B is a cross-sectional view of the touch display device taken along A-A′ line of FIG. 10A;

FIGS. 11A-11H are cross-sectional views of a method for fabricating a touch display device in accordance with one embodiment of the disclosure;

FIG. 12 is a top view of a touch display device in accordance with one embodiment of the disclosure;

FIG. 13A is a top view of a touch display device in accordance with one embodiment of the disclosure;

FIG. 13B is a cross-sectional view of the touch display device taken along A-A′ line of FIG. 13A;

FIG. 14A is a top view of a touch display device in accordance with one embodiment of the disclosure; and

FIG. 14B is a cross-sectional view of the touch display device taken along A-A′ line of FIG. 14A.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

The features of various embodiments may be combined or replaced to form other embodiments.

The term “disposed on” recited in the application means “directly on” or “indirectly on”.

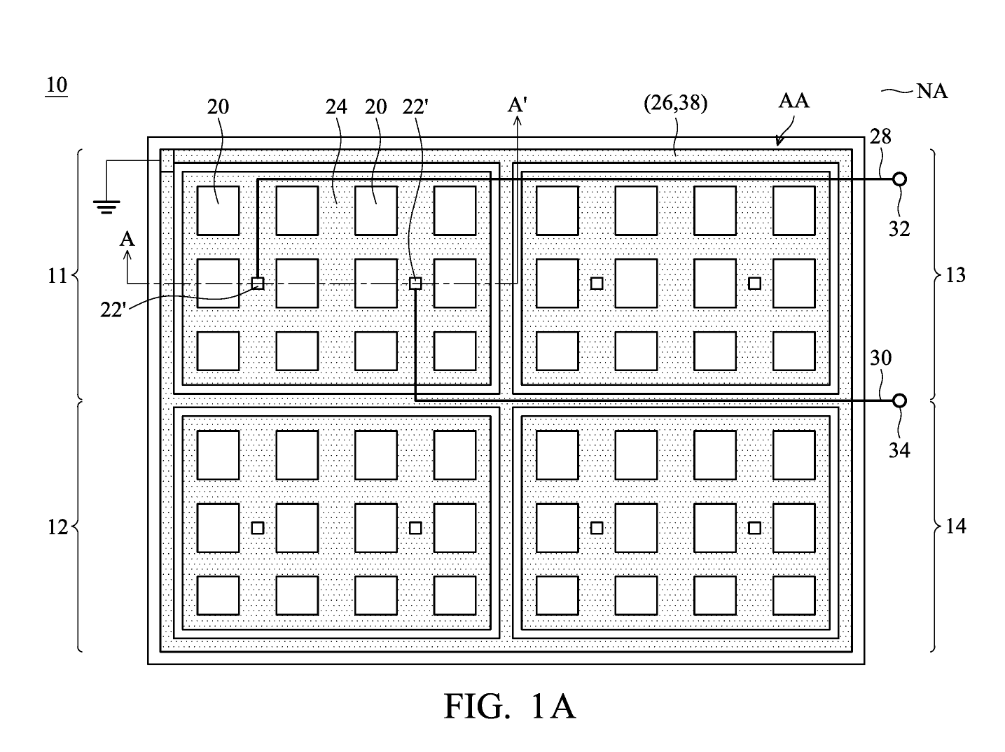

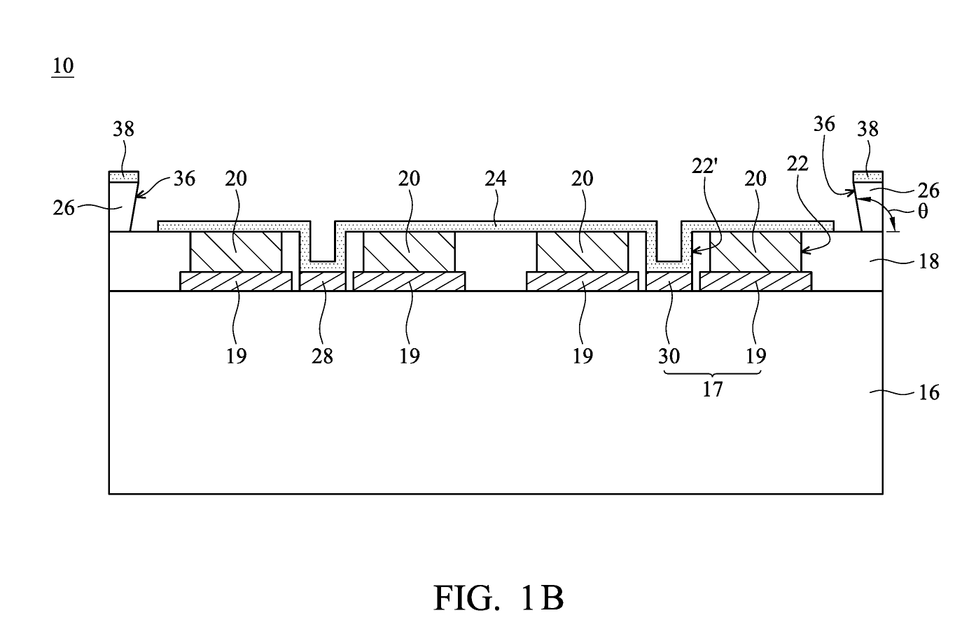

Referring to FIGS. 1A and 1B, in accordance with one embodiment of the disclosure, a touch display device 10 is provided. FIG. 1A is a top view of the touch display device 10. FIG. 1B is a cross-sectional view of the touch display device 10 taken along A-A′ line of FIG. 1A.

As shown in FIG. 1A, the touch display device 10 is a self-capacitance touch display device.

As shown in FIG. 1A, the touch display device 10 comprises a plurality of emitting blocks (11, 12, 13, 14). In this embodiment, the emitting block 11 is used as an example.

The touch display device 10 comprises a substrate 16, a conductive unit 17 comprising a first electrode 19 and a wire (28, 30) and disposed on the substrate 16, a first insulating layer 18 comprising a first opening 22 and a second opening 22′ and disposed on the conductive unit 17, a light emitting layer 20 disposed on the first electrode 19, a second electrode 24 disposed on the first insulating layer 18. The substrate 16 comprises a display area AA and a non-display area NA adjacent to the display area AA. The second electrode 24 electrically connects to the light emitting layer 20 and the first electrode 19 through the first opening 22. The second electrode 24 electrically connects to the wire (28, 30) through the second opening 22′. The wire (28, 30) extends from the display area AA to the non-display area NA and electrically connects to a signal source (32, 34). In this disclosure, the substrate 16 can be a rigid substrate or a flexible substrate. The rigid substrate can be made of glass, ceramic, sapphire, or other suitable material. The flexible substrate can be made of polyimide, polycarbonate, polyethylene terephthalate, or other suitable material. In this disclosure, the light emitting layer 20 can be an organic light emitting layer or an inorganic light emitting layer.

The wire (28, 30) and the first electrode 19 are on the same layer or different layers. In some embodiments, the first electrode 19 may be an anode underneath the light emitting layer 20. The wire (28, 30) may be a part of the first electrode 19. Specifically, the second electrode 24 may be used as a cathode and a touch electrode at the same time.

In this embodiment, the wire 28 electrically connects to the second electrode 24 and the signal source 32 through the second opening 22′. The wire 30 electrically connects to the second electrode 24 and the signal source 34 through the second opening 22′. Specifically, the signal source 32 may provide a signal to drive the cathode, and the signal source 34 may provide a signal to drive the touch electrode. In this embodiment, the signal source 32 and the signal source 34 may provide a signal for driving the cathode and a signal for driving the touch electrode, respectively, at the same time period or different time periods.

In some embodiments, the touch display device 10 further comprises an isolation layer 26 disposed on the first insulating layer 18 and surrounding the light emitting layer 20. The isolation layer 26 is not limited to a continuous and uninterrupted isolation layer which surrounds the light emitting layer 20. The isolation layer 26 may also be split into a plurality of discontinuous isolation layers. In some embodiments, the isolation layer 26 may comprise a single-layer structure or a double-layer structure. In this embodiment, the isolation layer 26 comprises a single-layer structure. By adjusting the parameters of the process, the etching degree of the lower portion is greater than the etching degree of the higher portion of the isolation layer 26, such that the isolation layer 26 with an inclined sidewall 36 is formed. Specifically, an inclined angle θ of the inclined sidewall 36 of the isolation layer 26 is greater than 90 degrees. In some embodiments, the isolation layer 26 has an inclined sidewall which shrinks inwardly from the top to the bottom thereof. It should be noted that the inclined angle referred to in the subsequent embodiments is based on the marks of FIG. 1B, and for the sake of simplicity, it is not repeatedly marked in figures.

In some embodiments, a third electrode 38 is further disposed on the isolation layer 26. Specifically, the third electrode 38 may be grounded as a grounding electrode, may receive a fixed potential as a common electrode, or may be floated as a floating electrode.

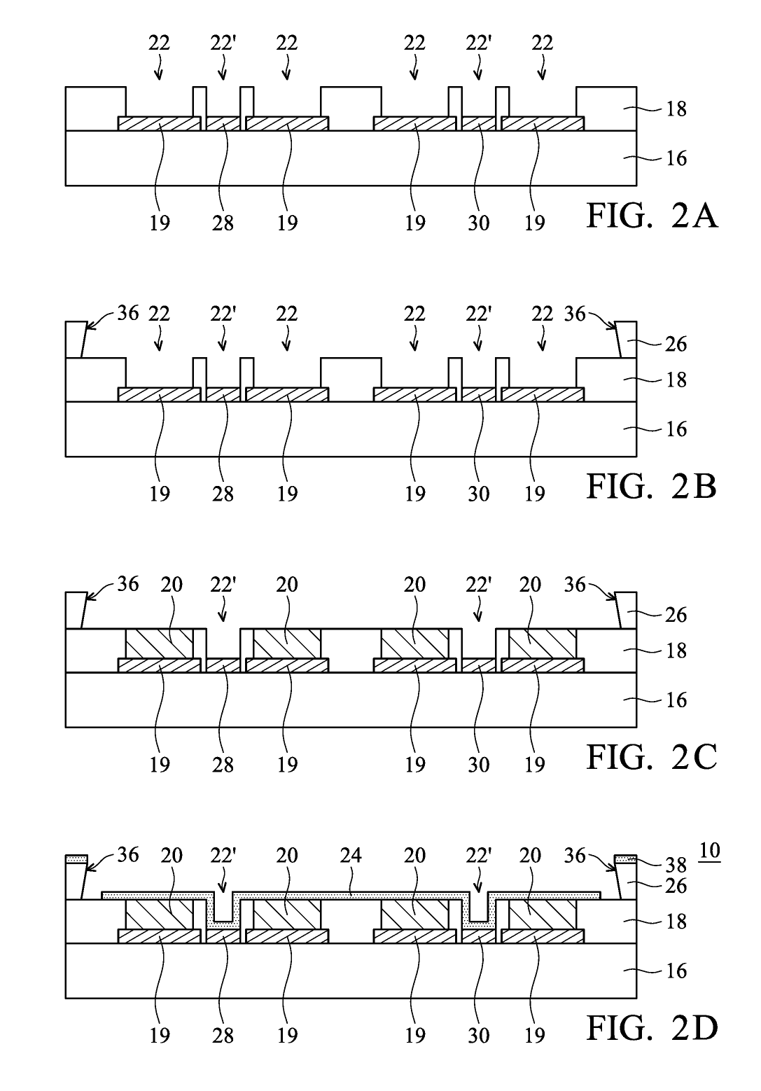

Referring to FIGS. 2A-2D, in accordance with the embodiment of FIGS. 1A-1B of the disclosure, a method for fabricating a touch display device is provided. FIGS. 2A-2D are cross-sectional views of a method for fabricating a touch display device.

As shown in FIG. 2A, a substrate 16 is provided. A patterned first insulating layer 18 is formed on the substrate 16. The patterned first insulating layer 18 has a plurality of first openings 22 and second openings 22′. Wire (28, 30) and a first electrode 19 (an anode) are respectively disposed in the first openings 22 and second openings 22′.

As shown in FIG. 2B, an isolation layer 26 is formed on the patterned first insulating layer 18. In this embodiment, the isolation layer 26 comprises a single-layer structure. By adjusting the parameters of the process, the etching degree of the lower portion is greater than the etching degree of the higher portion of the isolation layer 26, such that the isolation layer 26 with an inclined sidewall 36 is formed. Specifically, an inclined angle of the inclined sidewall 36 of the isolation layer 26 is greater than 90 degrees. In some embodiments, the isolation layer 26 has an inclined sidewall which shrinks inwardly from the top to the bottom thereof.

As shown in FIG. 2C, a light emitting layer 20 is disposed in the first openings 22 of the patterned first insulating layer 18.

As shown in FIG. 2D, next, a second electrode 24 is formed on the first insulating layer 18. The second electrode 24 electrically connects to the light emitting layer 20 and the first electrode 19 and fills into the second openings 22′ to connect the wire (28, 30). A third electrode 38 is formed on the isolation layer 26. Specifically, the third electrode 38 may be grounded as a grounding electrode, may receive a fixed potential as a common electrode, or may be floated as a floating electrode. In one embodiment of the disclosure, the second electrode 24 and the third electrode 38 are formed in the same step and contain the same material, but is not limited thereto. At this point, the fabrication of the touch display device 10 of this embodiment is thus completed.

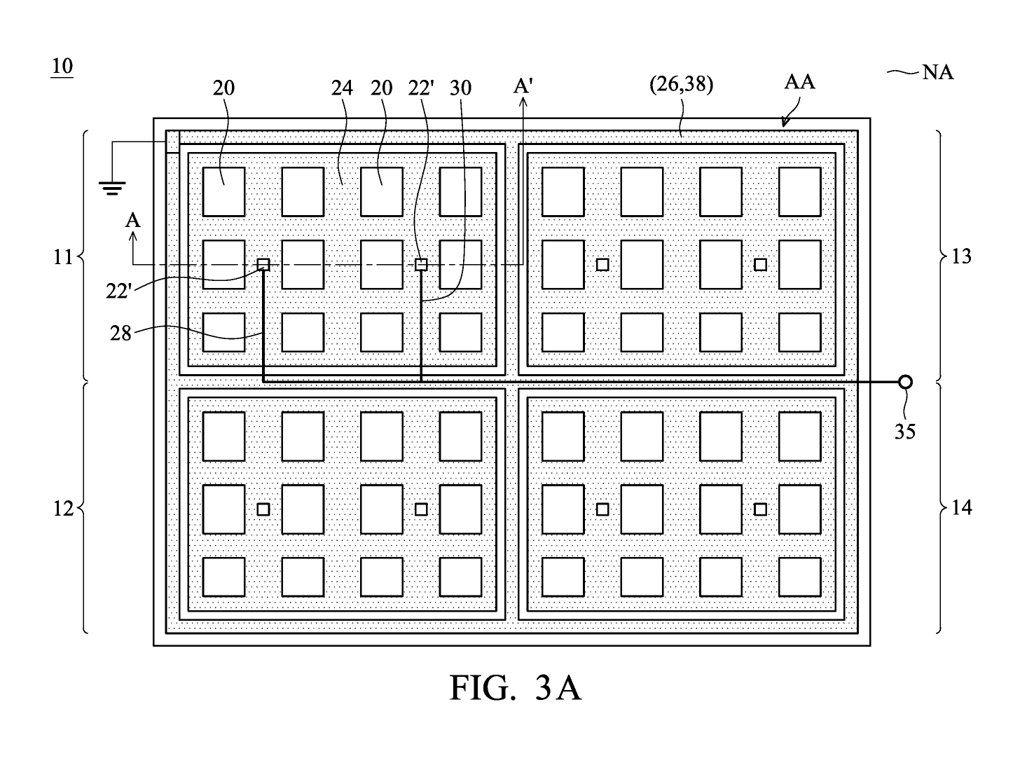

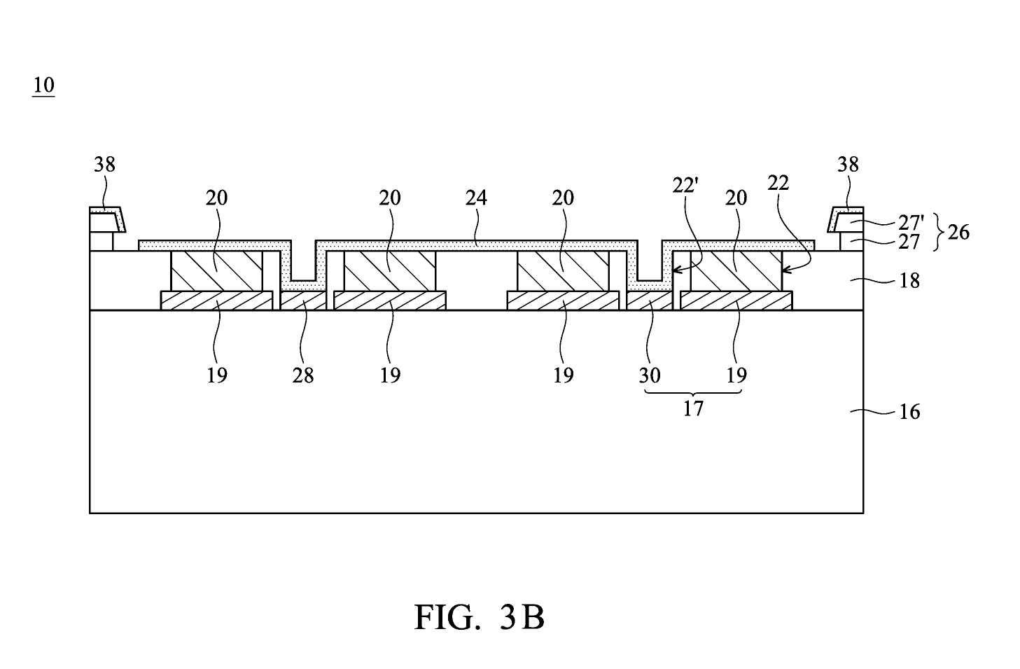

Referring to FIGS. 3A and 3B, in accordance with one embodiment of the disclosure, a touch display device 10 is provided. FIG. 3A is a top view of the touch display device 10. FIG. 3B is a cross-sectional view of the touch display device 10 taken along A-A′ line of FIG. 3A.

As shown in FIG. 3A, the touch display device 10 is a self-capacitance touch display device.

As shown in FIG. 3A, the touch display device 10 comprises a plurality of emitting blocks (11, 12, 13, 14). In this embodiment, the emitting block 11 is used as an example.

The touch display device 10 comprises a substrate 16, a conductive unit 17 comprising a first electrode 19 and a wire having two branches (28, 30) disposed on the substrate 16, a first insulating layer 18 comprising a first opening 22 and a second opening 22′ disposed on the conductive unit 17, a light emitting layer 20 disposed on the first electrode 19, a second electrode 24 disposed on the first insulating layer 18. The substrate 16 comprises a display area AA and a non-display area NA adjacent to the display area AA. The second electrode 24 electrically connects to the light emitting layer 20 and the first electrode 19 through the first opening 22. The second electrode 24 electrically connects to the branches (28, 30) of the wire through the second opening 22′. The two branches (28, 30) of the wire extend from the display area AA to the non-display area NA and electrically connects to a signal source 35.

The two branches (28, 30) of the wire and the first electrode 19 are on the same layer or different layers. In some embodiments, the first electrode 19 may be an anode underneath the light emitting layer 20. The two branches (28, 30) of the wire may be a part of the first electrode 19. Specifically, the second electrode 24 may be used as a cathode and a touch electrode at the same time.

In this embodiment, the branch 28 of the wire electrically connects to the second electrode 24 and the signal source 35 through the second opening 22′. The branch 30 of the wire electrically connects to the signal source 35 through the second opening 22′. Specifically, the signal source 35 may provide a signal to drive the cathode and a signal to drive the touch electrode. In this embodiment, the signal source 35 may provide a signal for driving the cathode and a signal for driving the touch electrode, respectively, at different time periods.

In some embodiments, the touch display device 10 further comprises an isolation layer 26 disposed on the first insulating layer 18 and surrounding the light emitting layer 20. The isolation layer 26 is not limited to a continuous and uninterrupted isolation layer which surrounds the light emitting layer 20. The isolation layer 26 may also be split into a plurality of discontinuous isolation layers. In some embodiments, the isolation layer 26 may comprise a single-layer structure or a double-layer structure. In this embodiment, the isolation layer 26 comprises a double-layer structure (e.g., a lower layer 27 and an upper layer 27′). Specifically, individual layers of the isolation layer 26 formed of the double-layer structure (e.g., the lower layer 27 and the upper layer 27′) have different etching degrees, for example, the etching degree of the lower layer 27 is greater than the etching degree of the higher layer 27′, such that the isolation layer 26 has an inwardly depressed sidewall from top to bottom. It should be noted that the thickness of the lower layer 27 is greater than the thickness of the second electrode 24.

In some embodiments, a third electrode 38 is further formed on the isolation layer 26. Specifically, the third electrode 38 may be grounded as a grounding electrode, may receive a fixed potential as a common electrode, or may be floated as a floating electrode.

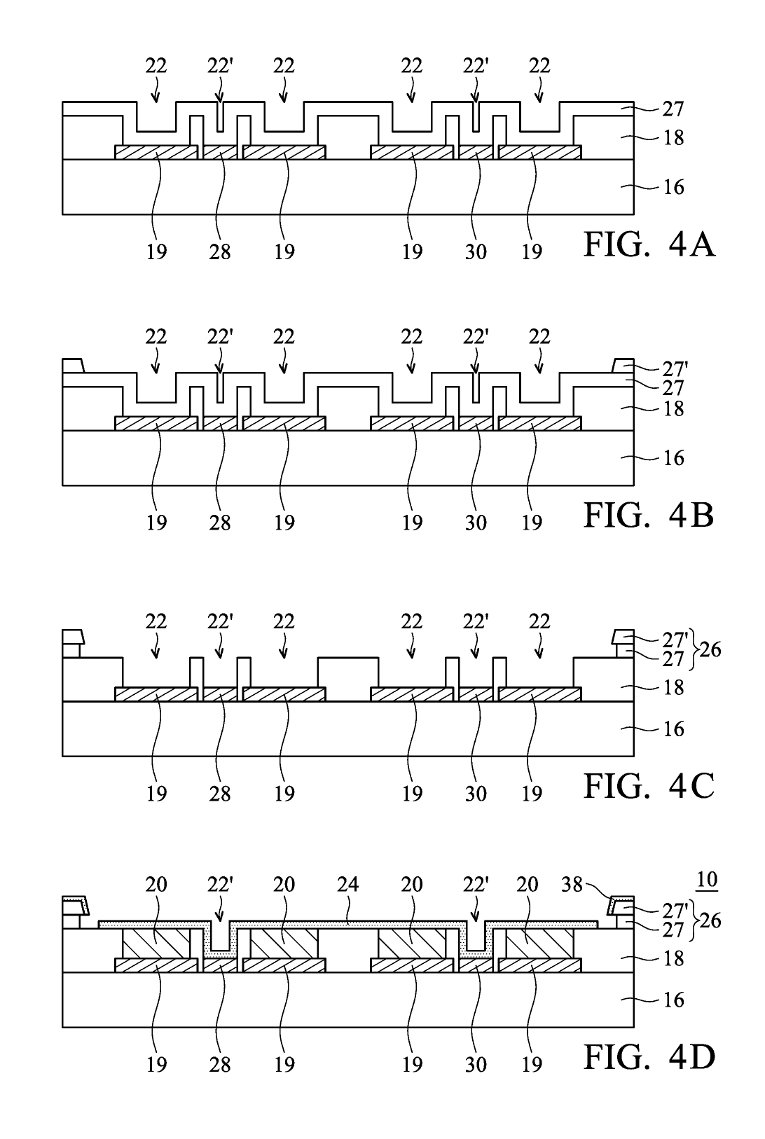

Referring to FIGS. 4A-4D, in accordance with the embodiment of FIGS. 3A-3B of the disclosure, a method for fabricating a touch display device is provided. FIGS. 4A-4D are cross-sectional views of a method for fabricating a touch display device.

As shown in FIG. 4A, a substrate 16 is provided. A patterned first insulating layer 18 is formed on the substrate 16. The patterned first insulating layer 18 has a plurality of first openings 22 and second openings 22′. Wire (28, 30) and a first electrode 19 (an anode) are respectively disposed in the first openings 22 and second openings 22′. Additionally, a first isolation layer 27 is conformally formed on the surface of the patterned first insulating layer 18 and overlies the wire (28, 30) and the first electrode 19.

As shown in FIG. 4B, a patterned second isolation layer 27′ is formed on the first isolation layer 27.

As shown in FIG. 4C, an etching process is performed on the first isolation layer 27 using, for example, the patterned second isolation layer 27′ as a mask to remove the first isolation layer 27 above the wires (28, 30) and the first electrode 19. An isolation layer 26 is then obtained.

In this embodiment, the isolation layer 26 comprises a double-layer structure (e.g., the lower layer 27 and the upper layer 27′). The materials of the double-layer structure (e.g., the lower layer 27 and the upper layer 27′) constituting the isolation layer 26 are different, for example, the lower layer 27 is an inorganic substance and the upper layer 27′ is an organic substance. Therefore, different etchants can be used to selectively etch the double-layer structure of the isolation layer 26. In some embodiments, while an over-etching treatment is performed on the first isolation layer 27, the obtained isolation layer 26 has an inwardly depressed sidewall from top to bottom.

As shown in FIG. 4D, a light emitting layer 20 is disposed in the first openings 22 of the patterned first insulating layer 18. Next, a second electrode 24 is formed on the first insulating layer 18. A third electrode 38 is simultaneously formed on the isolation layer 26. The second electrode 24 electrically connects to the light emitting layer 20 and the first electrode 19. A part of the second electrode 24 fills into the second openings 22′ to electrically connect the wire (28, 30). At this time, the thickness of the lower layer 27 is greater than the thickness of the second electrode 24. Specifically, the third electrode 38 may be used as a grounding electrode. In one embodiment of the disclosure, the second electrode 24 and the third electrode 38 are formed in the same step and contain the same material, but is not limited thereto. At this point, the fabrication of the touch display device 10 of this embodiment is thus completed.

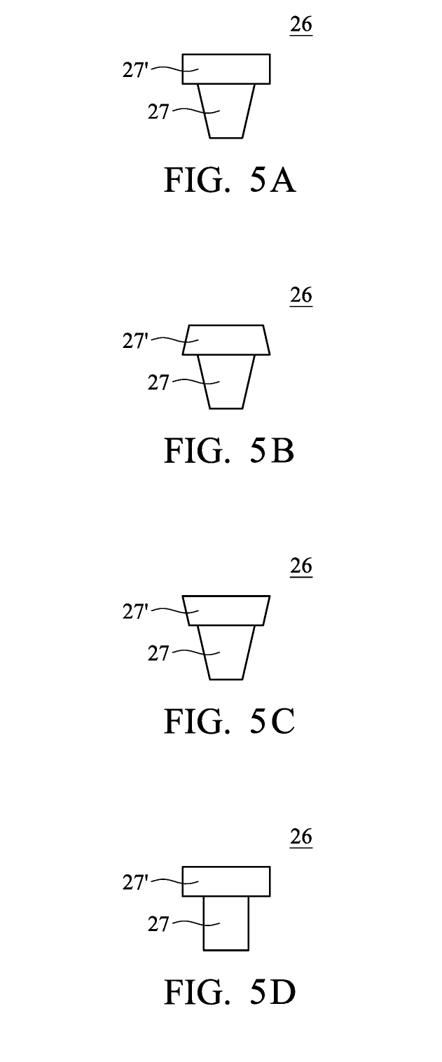

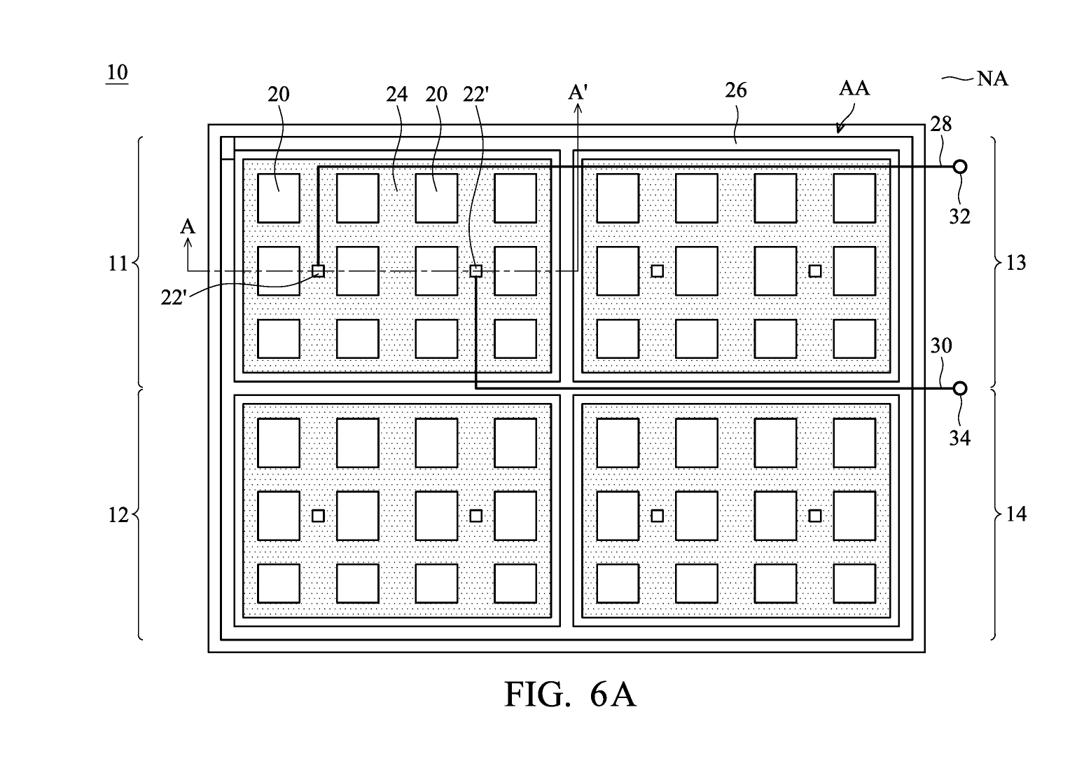

In some embodiments, the isolation layer 26 formed of the double-layer structure (e.g., the lower layer 27 and the upper layer 27′) may include a variety of patterns, such as combinations of a rectangle, a trapezoid or an inverted trapezoid, as shown in FIGS. 5A-5D. FIGS. 5A-5D are cross-sectional views of a variety of isolation layers with double-layer structures in accordance with the embodiments of the disclosure. As shown in FIG. 5A, the lower layer 27 is an inverted trapezoid and the upper layer 27′ is a rectangle. As shown in FIG. 5B, the lower layer 27 is an inverted trapezoid and the upper layer 27′ is a trapezoid. As shown in FIG. 5C, both of the lower layer 27 and the upper layer 27′ are inverted trapezoids. As shown in FIG. 5D, both of the lower layer 27 and the upper layer 27′ are rectangles. The double-layer structure generally constitutes a T like-type structure. In other words, the upper layer 27′ has a greater maximum width than the lower layer 27. And the width is measured in a direction parallel to a surface of the substrate 16.

In some embodiments, the T like-type structure constituted by the lower layer 27 and the upper layer 27′ of the isolation layer 26 may include a plurality of fabrication methods. In some embodiments, while the lower layer 27 and the upper layer 27′ of the isolation layer 26 are formed of a combination of two nonmetallic layers, the T like-type structure is formed using the etchant which has different etching rates for different materials. For example, the lower layer is silicon nitride (SiNx), the upper layer is silicon oxide (SiOx), and the etchant is sulfur hexafluoride (SF₆). Since the etching rate of sulfur hexafluoride for silicon nitride is greater than that of sulfur hexafluoride for silicon oxide, under the same etching time, the etching degree of the lower layer is greater than that of the upper layer such that the T like-type structure is thus formed. It should be noted that the material of the lower layer 27 or the upper layer 27′ of the isolation layer 26 is not limited thereto, and other materials are appropriate. For example, the materials of the lower layer 27 and the upper layer 27′ are silicon nitrides (SiNx) which are formed by different film formation conditions or rates, resulting in the differences of hardness or density between the upper and lower layers.

In some embodiments, the lower layer 27 and the upper layer 27′ of the isolation layer 26 are formed of a combination of two metal layers, for example, the lower layer 27 is molybdenum (Mo) and the upper layer 27′ is aluminum (Al). In order to make an etchant have different etching rates for molybdenum and aluminum, “aluminic acid” may be selected as the etchant, but the metal material and the etchant in this embodiment are not limited thereto.

In some embodiments, the lower layer 27 and the upper layer 27′ of the isolation layer 26 are formed of a combination of a metal layer and a nonmetallic layer, for example, the lower layer 27 is molybdenum (Mo) and the upper layer 27′ is silicon nitride (SiNx). First, the upper layer of silicon nitride is etched by a dry etching, and then the lower layer of molybdenum is over-etched by a wet etching. Finally, the T like-type structure can also be obtained. It should be noted that the combination of the metal material and the nonmetallic material in this embodiment are not limited thereto.

In some embodiments, the lower layer 27 and the upper layer 27′ of the isolation layer 26 are formed of a combination of two photoresist layers. The photoresist with a higher photoreactivity is selected as the upper layer. After an exposure, the hardening rate of the upper photoresist layer is faster than that of the lower photoresist layer, therefore, under the same exposure time, after developing, the T like-type structure is formed from the two photoresist layers.

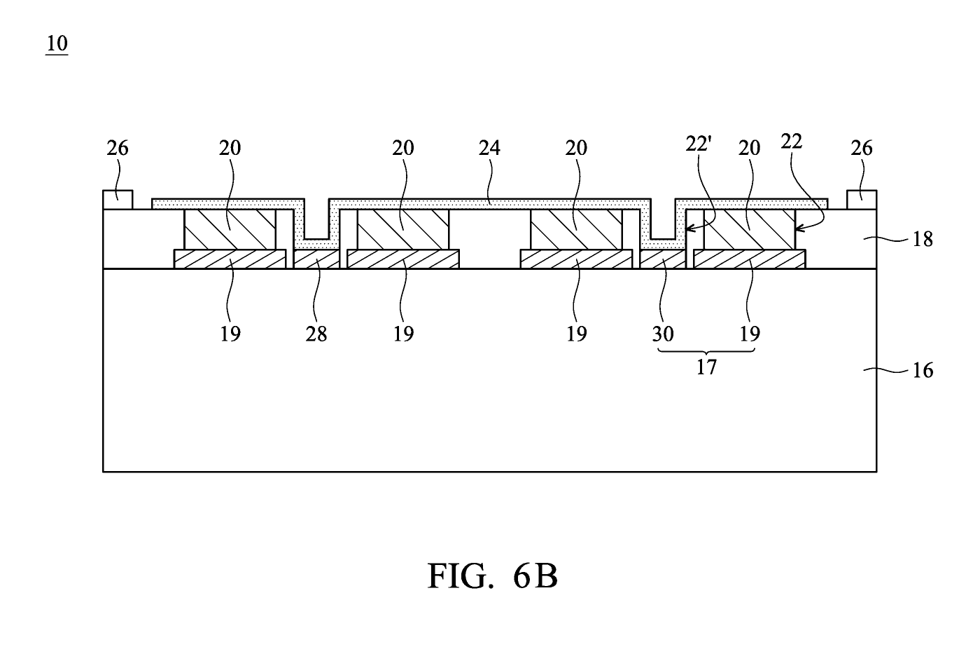

Referring to FIGS. 6A and 6B, in accordance with one embodiment of the disclosure, a touch display device 10 is provided. FIG. 6A is a top view of the touch display device 10. FIG. 6B is a cross-sectional view of the touch display device 10 taken along A-A′ line of FIG. 6A.

As shown in FIG. 6A, the touch display device 10 is a self-capacitance touch display device.

As shown in FIG. 6A, the touch display device 10 comprises a plurality of emitting blocks (11, 12, 13, 14). In this embodiment, the emitting block 11 is used as an example.

The touch display device 10 comprises a substrate 16, a conductive unit 17 comprising a first electrode 19 and a wire (28, 30) disposed on the substrate 16, a first insulating layer 18 comprising a first opening 22 and a second opening 22′ disposed on the conductive unit 17, a light emitting layer 20 disposed on the first electrode 19, a second electrode 24 disposed on the first insulating layer 18. The substrate 16 comprises a display area AA and a non-display area NA adjacent to the display area AA. The second electrode 24 electrically connects to the light emitting layer 20 and the first electrode 19 through the first opening 22. The second electrode 24 electrically connects to the wire (28, 30) through the second opening 22′. The wire (28, 30) extends from the display area AA to the non-display area NA and electrically connects to a signal source (32, 34).

The wire (28, 30) and the first electrode 19 are on the same layer or different layers. In some embodiments, the first electrode 19 may be an anode underneath the light emitting layer 20. The wire (28, 30) may be a part of the first electrode 19. Specifically, the second electrode 24 may be used as a cathode and a touch electrode at the same time.

In this embodiment, the wire 28 electrically connects to the second electrode 24 and the signal source 32 through the second opening 22′. The wire 30 electrically connects to the second electrode 24 and the signal source 34 through the second opening 22′. Specifically, the signal source 32 may provide a signal to drive the cathode, and the signal source 34 may provide a signal to drive the touch electrode. In this embodiment, the signal source 32 and the signal source 34 may provide a signal for driving the cathode and a signal for driving the touch electrode, respectively, at the same time period or different time periods.

In some embodiments, the touch display device 10 further comprises an isolation layer 26 disposed on the first insulating layer 18 and surrounding the light emitting layer 20. The isolation layer 26 is not limited to a continuous and uninterrupted isolation layer which surrounds the light emitting layer 20. The isolation layer 26 may also be split into a plurality of discontinuous isolation layers. In some embodiments, the isolation layer 26 may comprise a single-layer structure or a double-layer structure. In this embodiment, the isolation layer 26 comprises a single-layer structure.

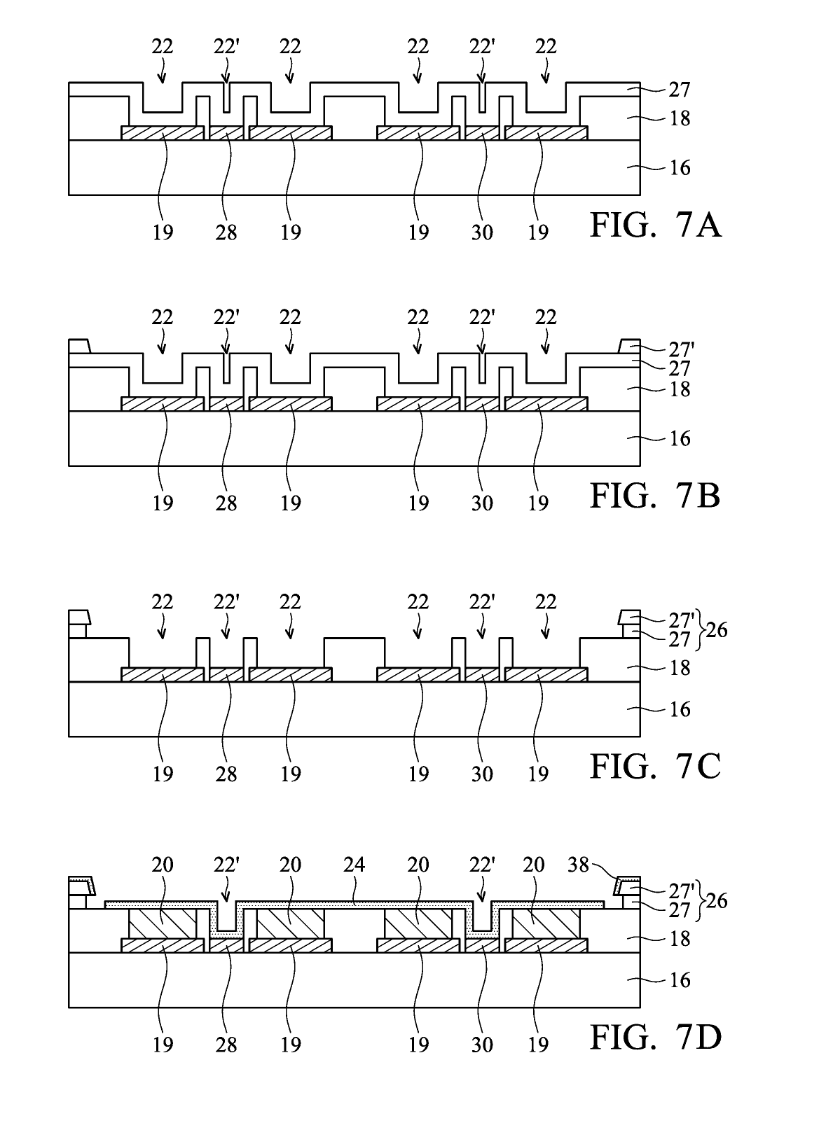

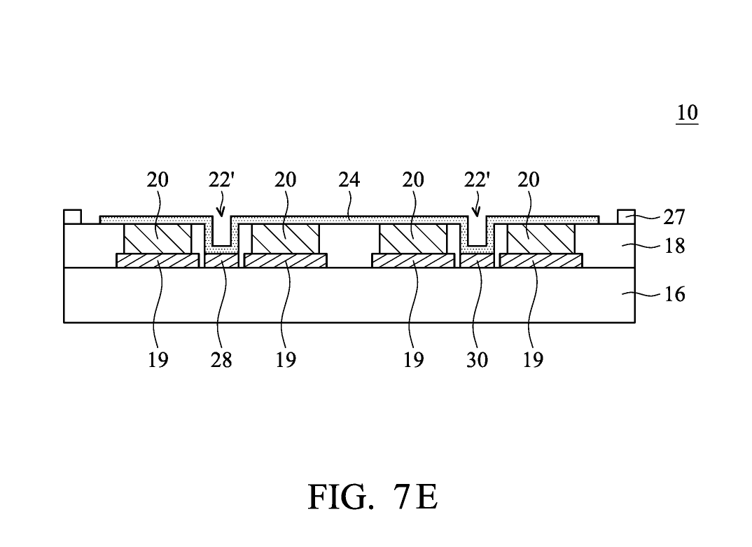

Referring to FIGS. 7A-7E, in accordance with the embodiment of FIGS. 6A-6B of the disclosure, a method for fabricating a touch display device is provided. FIGS. 7A-7E are cross-sectional views of a method for fabricating a touch display device.

As shown in FIG. 7A, a substrate 16 is provided. A patterned first insulating layer 18 is formed on the substrate 16. The patterned first insulating layer 18 has a plurality of first openings 22 and second openings 22′. Wire (28, 30) and a first electrode 19 (an anode) are respectively disposed in the first openings 22 and second openings 22′. Additionally, a first isolation layer 27 is conformally formed on the surface of the patterned first insulating layer 18 and overlies the wire (28, 30) and the first electrode 19.

As shown in FIG. 7B, a patterned second isolation layer 27′ is formed on the first isolation layer 27.

As shown in FIG. 7C, an etching process is performed on the first isolation layer 27 using, for example, the patterned second isolation layer 27′ as a mask to remove the first isolation layer 27 above the wire (28, 30) and the first electrode 19. A double-layer structure 26 is then obtained.

The materials of the first isolation layer 27 and the second isolation layer 27′ are different, for example, the first isolation d layer 27 is an inorganic substance and the second isolation layer 27′ is an organic substance. Different etchants can be used to selectively etch the double-layer structure. While an over-etching treatment is performed on the first isolation layer 27, a T like-type structure can be obtained. In some embodiments, the etchant has different etching rates for the first isolation layer 27 and the second isolation layer 27′. At this time, the first isolation layer 27 and the second isolation layer 27′ are simultaneously patterned to obtain a T like-type structure.

As shown in FIG. 7D, a light emitting layer 20 is disposed in the first openings 22 of the patterned first insulating layer 18. Next, a second electrode 24 is formed on the first insulating layer 18. A third electrode 38 is formed on the double-layer structure 26. The second electrode 24 electrically connects to the light emitting layer 20 and the first electrode 19. A part of the second electrode 24 fills into the second openings 22′ to electrically connect the wire (28, 30). At this time, the thickness of the first isolation layer 27 is greater than the thickness of the second electrode 24. In one embodiment of the disclosure, the second electrode 24 and the third electrode 38 are formed in the same step and contain the same material, but is not limited thereto.

As shown in FIG. 7E, an etching process is performed to remove the third electrode 38 and the second isolation layer 27′, leaving the first isolation layer 27. At this time, the thickness of the first isolation layer 27 is greater than the thickness of the second electrode 24. At this point, the fabrication of the touch display device 10 of this embodiment is thus completed.

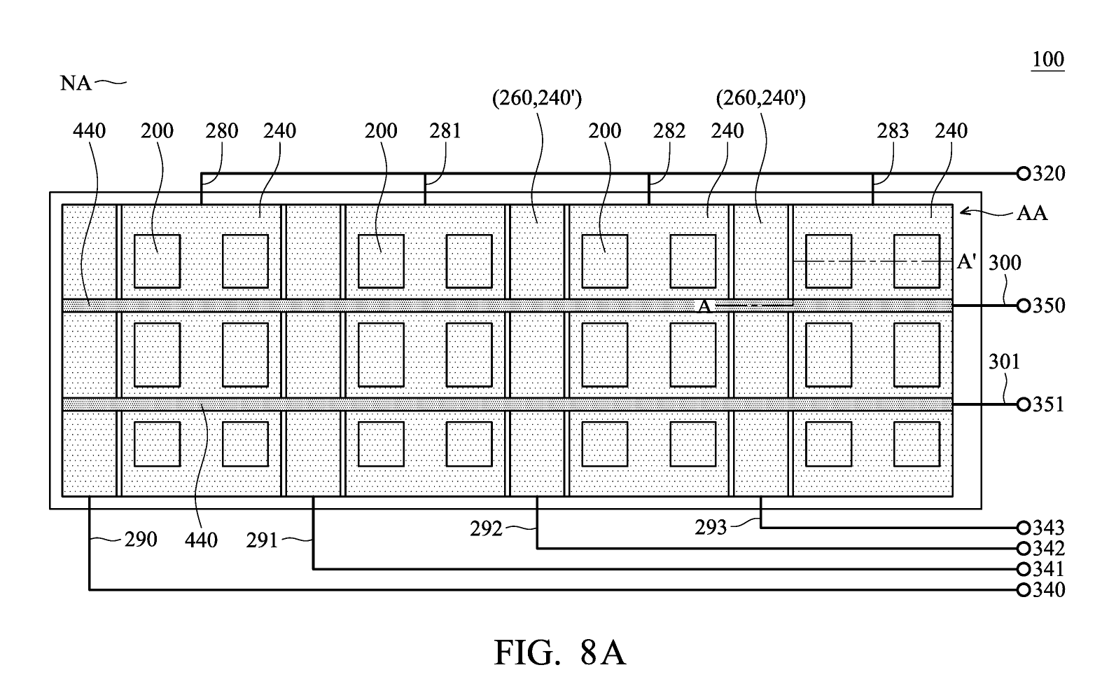

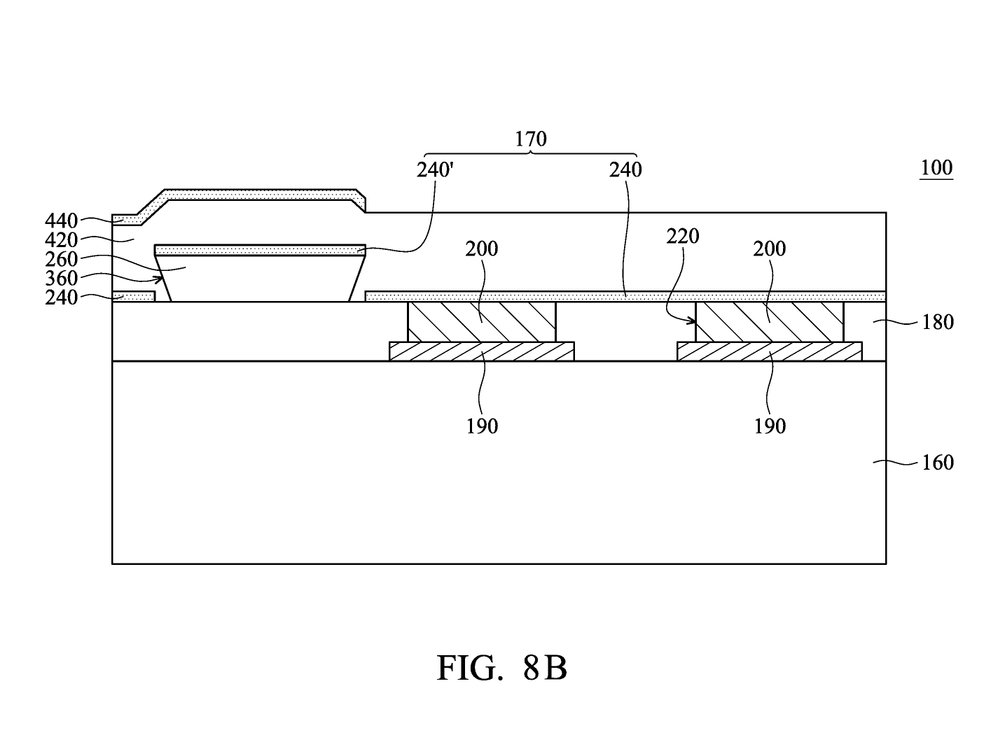

Referring to FIGS. 8A and 8B, in accordance with one embodiment of the disclosure, a touch display device 100 is provided. FIG. 8A is a top view of the touch display device 100. FIG. 8B is a cross-sectional view of the touch display device 100 taken along A-A′ line of FIG. 8A.

As shown in FIG. 8A, the touch display device 100 is a mutual-capacitance touch display device.

The touch display device 100 comprises a substrate 160; a first electrode 190 disposed on the substrate 160; a first insulating layer 180 comprising an opening 220 and disposed on the first electrode 190; a light emitting layer 200 disposed on the first electrode 190; a conductive unit 170 comprising a second electrode 240 and a third electrode 240′ disposed on the first insulating layer 180; a second insulating layer 420 disposed on the conductive unit 170; a fourth electrode 440 disposed on the second insulating layer 420; a first wire (290, 291, 292, 293) electrically connects to the third electrode 240′; and a second wire (300, 301) electrically connects to the fourth electrode 440; and a third wire (280, 281, 282, 283) electrically connects to the second electrode 240. The substrate 160 comprises a display area AA and a non-display area NA adjacent to the display area AA. The second electrode 240 above the first insulating layer 180 and electrically connects to the light emitting layer 200 and the first electrode 190 through the opening 220. The second electrode 240 is electrically isolated from the third electrode 240′. The third electrode 240′ electrically connects to a first signal source (340, 341, 342, 343) through the first wire (290, 291, 292, 293). The fourth electrode 440 electrically connects to a second signal source (350, 351) through the second wire (300, 301). The second electrode 240 electrically connects to a third signal source 320 through the third wire (280, 281, 282, 283). In some embodiments, the first electrode 190 may be used as an anode underneath the light emitting layer 200. Specifically, the second electrode 240 may be used as a cathode.

In this embodiment, the third wire (280, 281, 282 and 283) electrically connects to the second electrode 240 and the signal source 320. The first wire (290, 291, 292 and 293) electrically connects to the third electrode 240′ and the signal source (340, 341, 342 and 343). The second wire (300, 301) electrically connects to the fourth electrode 440 and the signal source (350, 351). Specifically, the signal source 320 may provide a signal to drive the cathode. The signal source (340, 341, 342 and 343) may provide a drive signal Tx. The signal source (350, 351) may receive a sensing signal Rx. In other embodiments, the signal source (350, 351) may provide a drive signal Tx. The signal source (340, 341, 342 and 343) may receive a sensing signal Rx. In this embodiment, the signal source (320, 340, 341, 342, 343, 350 and 351) may provide a signal for driving the cathode and a drive signal Tx, and may receive a sensing signal Rx, respectively, at the same time period or different time periods.

In some embodiments, the touch display device 100 further comprises an isolation layer 260 disposed between the first insulating layer 180 and the second insulating layer 420, and surrounding the light emitting layer 200. The isolation layer 260 is not limited to a continuous and uninterrupted isolation layer which surrounds the light emitting layer 200. The isolation layer 260 may also be split into a plurality of discontinuous isolation layers. In some embodiments, the isolation layer 260 may comprise a single-layer structure or a double-layer structure. In this embodiment, the isolation layer 260 comprises a single-layer structure. By adjusting the parameters of the process, the etching degree of the lower portion is greater than the etching degree of the higher portion of the isolation layer 260, such that the isolation layer 260 with an inclined sidewall 360 is formed. Specifically, an inclined angle of the inclined sidewall 360 of the isolation layer 260 is greater than 90 degrees. In some embodiments, the isolation layer 260 has an inclined sidewall which shrinks inwardly from the top to the bottom thereof. In this embodiment, the thickness of the isolation layer 260 formed of the single-layer structure is greater than the thickness of the second electrode 240. Additionally, the third electrode 240′ is disposed on the isolation layer 260.

In some embodiments, the double-layer structure may be a T like-type structure.

In some embodiments, the fourth electrode 440 may be made of, for example, a transparent material such as ITO, IZO, ITZO or IGZO. In some embodiments, the fourth electrode 440 may be made of, for example, a non-transparent material such as metal.

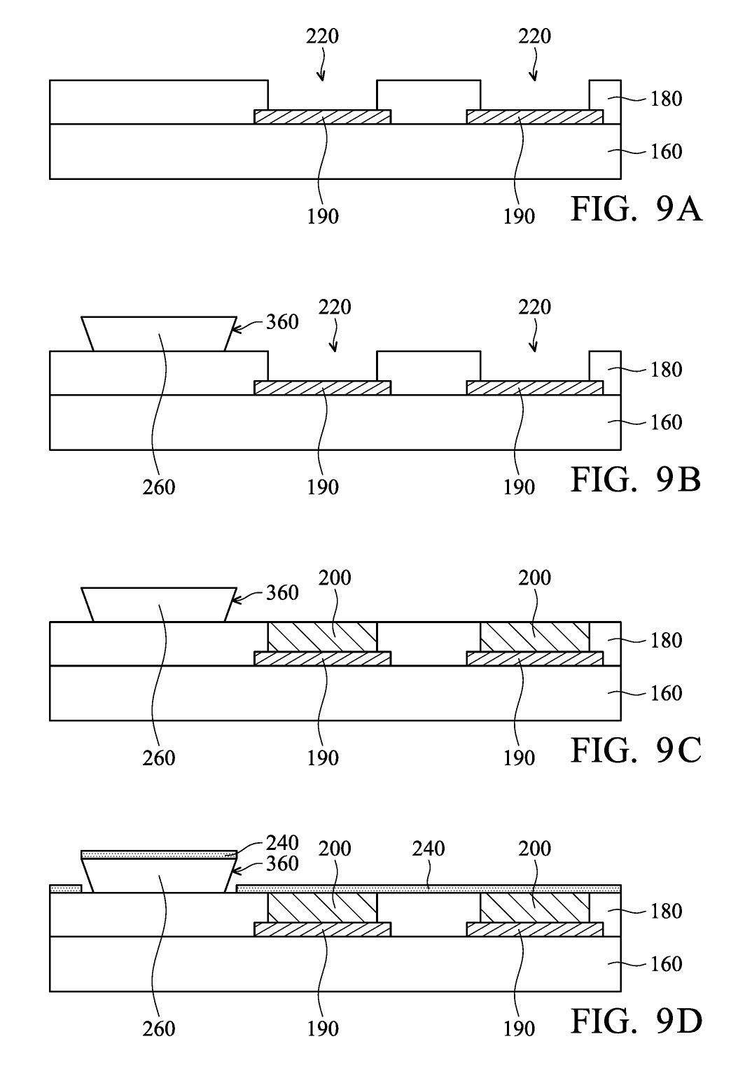

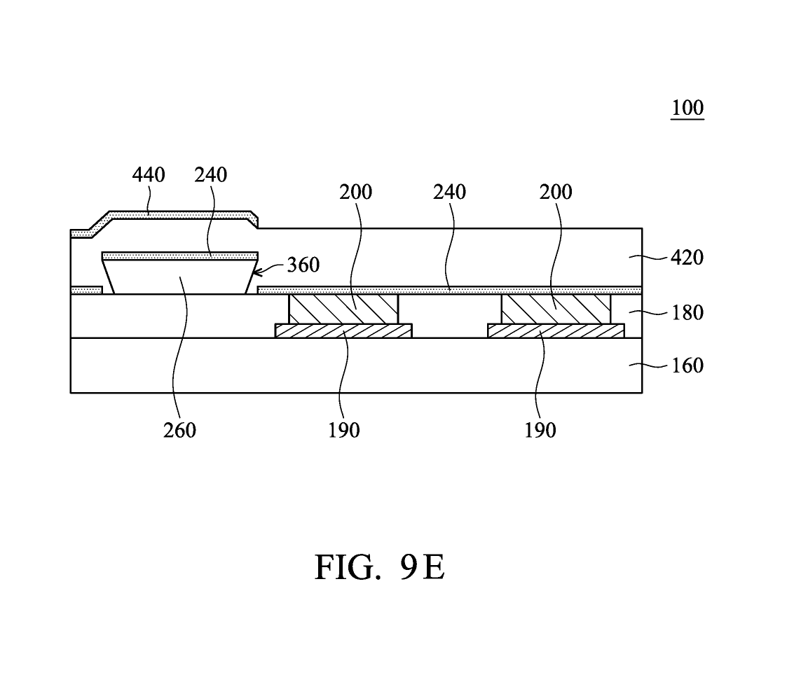

Referring to FIGS. 9A-9E, in accordance with the embodiment of FIGS. 8A-8B of the disclosure, a method for fabricating a touch display device is provided. FIGS. 9A-9E are cross-sectional views of a method for fabricating a touch display device.

As shown in FIG. 9A, a substrate 160 is provided. A patterned first insulating layer 180 is formed on the substrate 160. The patterned first insulating layer 180 has a plurality of openings 220. A first electrode 190 (an anode) is disposed in the openings 220. In other embodiments, before the first insulating layer 180 is formed, a patterned first electrode 190 has been formed on the substrate 160.

As shown in FIG. 9B, an isolation layer 260 is formed on the patterned first insulating layer 180.

In some embodiments, the isolation layer 260 may comprise a single-layer structure or a double-layer structure. In this embodiment, the isolation layer 260 comprises a single-layer structure. By adjusting the parameters of the process, the etching degree of the lower portion is greater than the etching degree of the higher portion of the isolation layer 260, such that the isolation layer 260 with an inclined sidewall 360 is formed. Specifically, an inclined angle of the inclined sidewall 360 of the isolation layer 260 is greater than 90 degrees. In some embodiments, the isolation layer 260 has an inclined sidewall which shrinks inwardly from the top to the bottom thereof.

As shown in FIG. 9C, a light emitting layer 200 is disposed in the openings 220 of the patterned first insulating layer 180.

As shown in FIG. 9D, a second electrode 240 is formed on the first insulating layer 180 and the isolation layer 260. A part of the second electrode 240 electrically connects to the light emitting layer 200 and the first electrode 190. The isolation layer 260 is arranged in an alternating manner with the second electrode 240 which electrically connects to the light emitting layer 200. In some embodiments, the thickness of the isolation layer 260 formed of the single-layer structure is greater than the thickness of the second electrode 240.

As shown in FIG. 9E, a second insulating layer 420 is formed on the first insulating layer 180, the isolation layer 260 and the second electrode 240. Next, a fourth electrode layer 440 is formed on the second insulating layer 420. At this point, the fabrication of the touch display device 100 of this embodiment is thus completed.

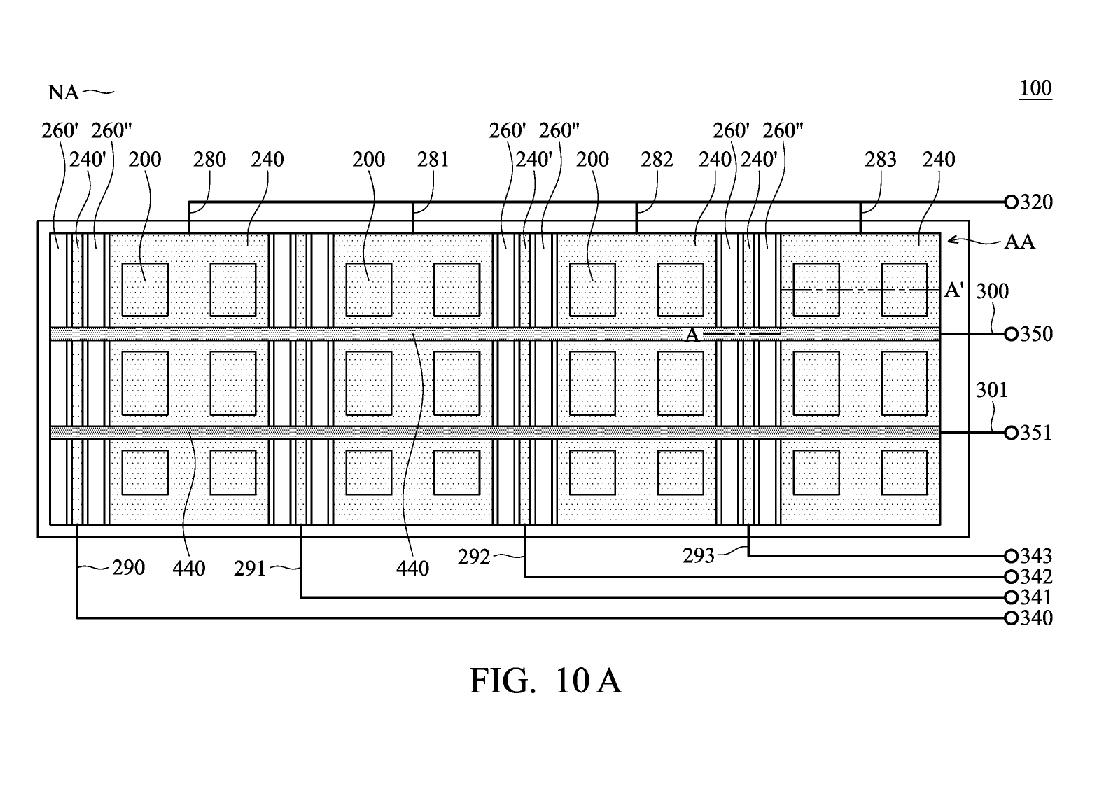

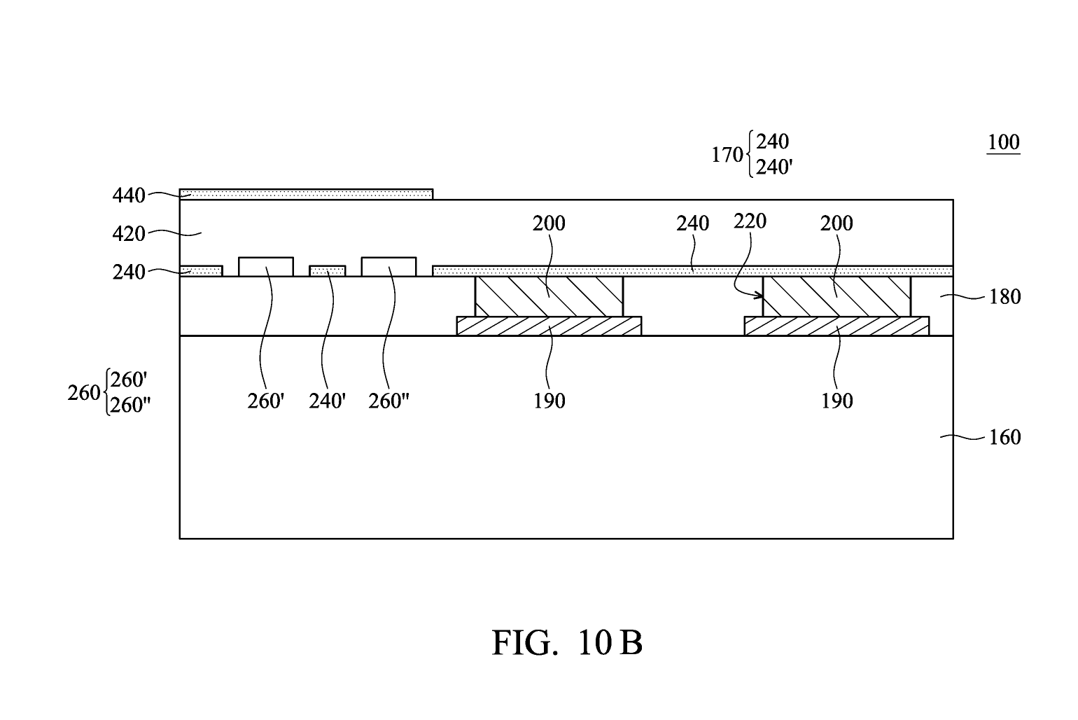

Referring to FIGS. 10A and 10B, in accordance with one embodiment of the disclosure, a touch display device 100 is provided. FIG. 10A is a top view of the touch display device 100. FIG. 10B is a cross-sectional view of the touch display device 100 taken along A-A′ line of FIG. 10A.

As shown in FIG. 10A, the touch display device 100 is a mutual-capacitance touch display device.

The touch display device 100 comprises a substrate 160; a first electrode 190 disposed on the substrate 160; a first insulating layer 180 comprising an opening 220 disposed on the first electrode 190; a light emitting layer 200 disposed on the first electrode 190; a conductive unit 170 comprising a second electrode 240 and a third electrode 240′ disposed on the first insulating layer 180; a second insulating layer 420 disposed on the conductive unit 170; a fourth electrode 440 disposed on the second insulating layer 420; a first wire (290, 291, 292, 293) electrically connects to the third electrode 240′; and a second wire (300, 301) electrically connects to the fourth electrode 440; and a third wire (280, 281, 282, 283) electrically connects to the second electrode 240. The substrate 160 comprises a display area AA and a non-display area NA adjacent to the display area AA. The second electrode 240 above the first insulating layer 180 electrically connects to the light emitting layer 200 and the first electrode 190 through the opening 220. The second electrode 240 is electrically isolated from the third electrode 240′. The third electrode 240′ electrically connects to a first signal source (340, 341, 342, 343) through the first wire (290, 291, 292, 293). The fourth electrode 440 electrically connects to a second signal source (350, 351) through the second wire (300, 301). The second electrode 240 electrically connects to a third signal source 320 through the third wire (280, 281, 282, 283). In some embodiments, the first electrode 190 may be used as an anode underneath the light emitting layer 200. Specifically, the second electrode 240 may be used as a cathode.

In this embodiment, the third wire (280, 281, 282 and 283) electrically connects to the second electrode 240 and the third signal source 320. The first wire (290, 291, 292 and 293) electrically connects to the third electrode 240′ and the first signal source (340, 341, 342 and 343). The second wire (300, 301) electrically connects to the fourth electrode 440 and the second signal source (350, 351). Specifically, the signal source 320 may provide a signal to drive the cathode. The signal source (340, 341, 342 and 343) may provide a drive signal Tx. The signal source (350, 351) may receive a sensing signal Rx. In other embodiments, the signal source (350, 351) may provide a drive signal Tx. The signal source (340, 341, 342 and 343) may receive a sensing signal Rx. In this embodiment, the signal source (320, 340, 341, 342, 343, 350 and 351) may provide a signal for driving the cathode and a drive signal Tx, and may receive a sensing signal Rx, respectively, at the same time period or different time periods.

In some embodiments, the touch display device 100 further comprises an isolation layer 260 disposed between the first insulating layer 180 and the second insulating layer 420, and surrounding the light emitting layer 200. The isolation layer 260 is not limited to a continuous and uninterrupted isolation layer which surrounds the light emitting layer 200. The isolation layer 260 may also be split into a plurality of discontinuous isolation layers. In some embodiments, the isolation layer 260 may comprise a single-layer structure or a double-layer structure. In this embodiment, the isolation layer 260 comprises a single-layer structure. The thickness of the isolation layer 260 is greater than the thickness of the second electrode 240. It should be noted that, in this embodiment, the isolation layer 260 comprises two separated portions (260′, 260″), and the third electrode 240′ is disposed between the two separated portions (260′, 260″).

In some embodiments, the second electrode 240 and the third electrode 240′ may be made of, for example, a transparent material such as ITO, IZO, ITZO or IGZO. In some embodiments, the fourth electrode 440 may be made of, for example, a non-transparent material such as metal.

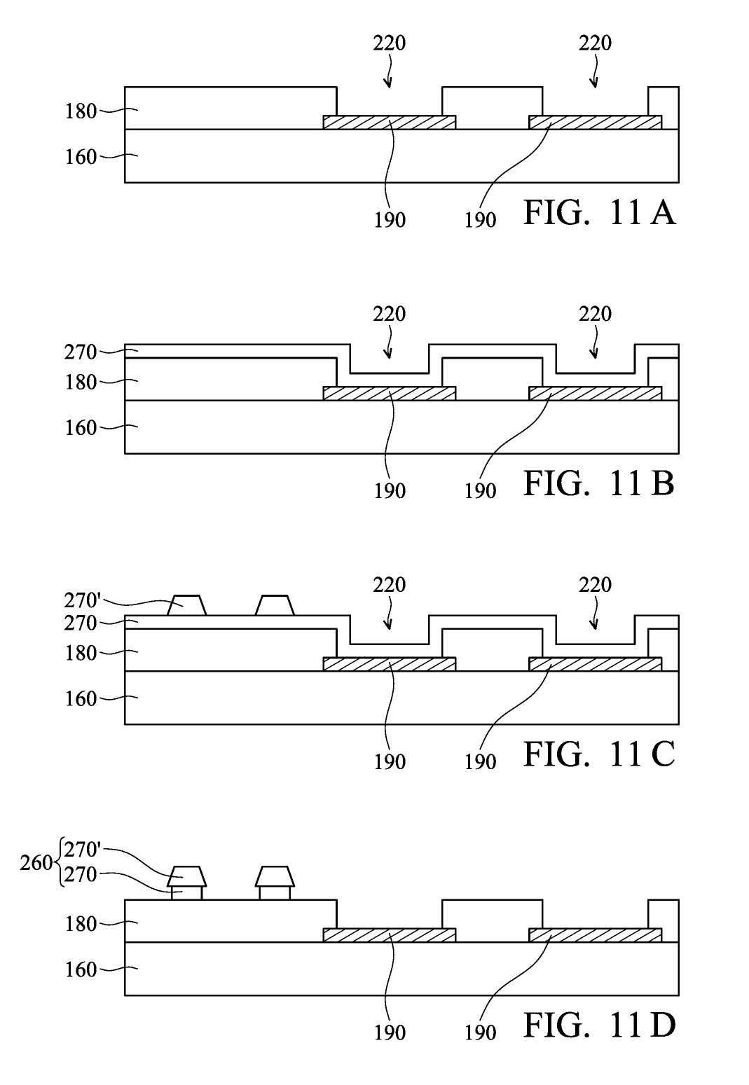

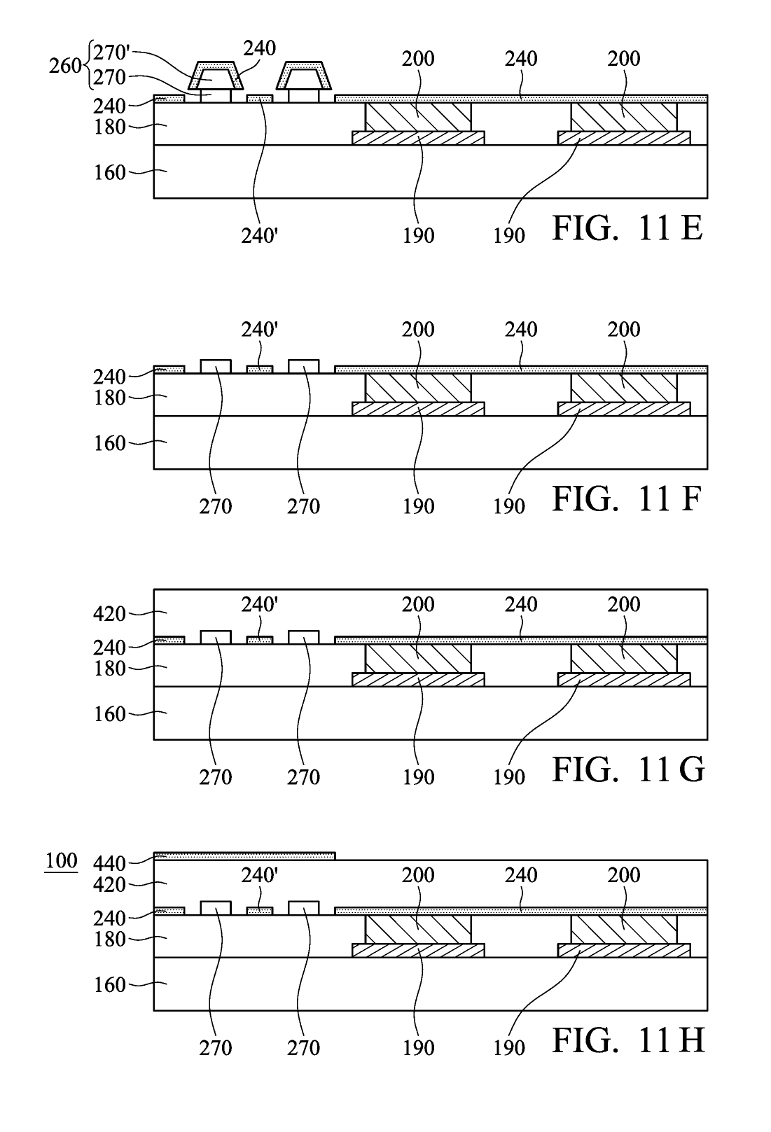

Referring to FIGS. 11A-11H, in accordance with the embodiment of FIGS. 10A-10B of the disclosure, a method for fabricating a touch display device is provided. FIGS. 11A-11H are cross-sectional views of a method for fabricating a touch display device.

As shown in FIG. 11A, a substrate 160 is provided. A patterned first insulating layer 180 is formed on the substrate 160. The patterned first insulating layer 180 has a plurality of openings 220. A first electrode 190 (an anode) is disposed in the openings 220. In other embodiments, before the first insulating layer 180 is formed, a patterned first electrode 190 has been formed on the substrate 160.

As shown in FIG. 11B, a first isolation layer 270 is conformally formed on the surface of the patterned first insulating layer 180 and overlies the first electrode 190.

As shown in FIG. 11C, a patterned second isolation layers 270′ is formed on the first isolation layer 270.

As shown in FIG. 11D, an etching process is performed on the first isolation layer 270 using, for example, the patterned second isolation layer 270′ as a mask to remove the first isolation layer 270 above the first electrode 190 and above the surface of a part of the patterned first insulating layer 180. An isolation layer 260 with a double-layer structure is then formed.

The materials of the first isolation layer 270 and the second isolation layer 270′ are different, for example, the first isolation layer 270 is an inorganic substance and the second isolation layer 270′ is an organic substance. Different etchants can be used to selectively etch the double-layer structure. While an over-etching treatment is performed on the first isolation layer 270, a T like-type structure can be obtained. In other embodiments, the etchant has different etching rates for the first isolation layer 270 and the second isolation layer 270′. At this time, the first isolation layer 270 and the second isolation layer 270′ are simultaneously patterned to obtain a T like-type structure.

As shown in FIG. 11E, a light emitting layer 200 is disposed in the openings 220 of the patterned first insulating layer 180. Next, a second electrode 240 and a third electrode 240′ are formed on the first insulating layer 180 and the double-layer structures 260. The second electrode 240 electrically connects to the light emitting layer 200 and the first electrode 190. The thickness of the first isolation layer 270 is greater than the thickness of the second electrode 240 and the third electrode 240′.

As shown in FIG. 11F, an etching process is performed to remove the second electrode 240 above the double-layer structures 260 and remove the second isolation layer 270′, leaving the first isolation layer 270. The thickness of the first isolation layer 270 is greater than the thickness of the second electrode 240 and the third electrode 240′. In this embodiment, the first isolation layer 270 comprises two separated portions, and the third electrode 240′ is disposed between the two separated portions.

As shown in FIG. 11G, a second insulating layer 420 is formed on the first insulating layer 180, the first isolation layer 270, the second electrode 240, and the third electrode 240′.

As shown in FIG. 11H, a fourth electrode 440 is formed on the second insulating layer 420. At this point, the fabrication of the touch display device 100 of this embodiment is thus completed.

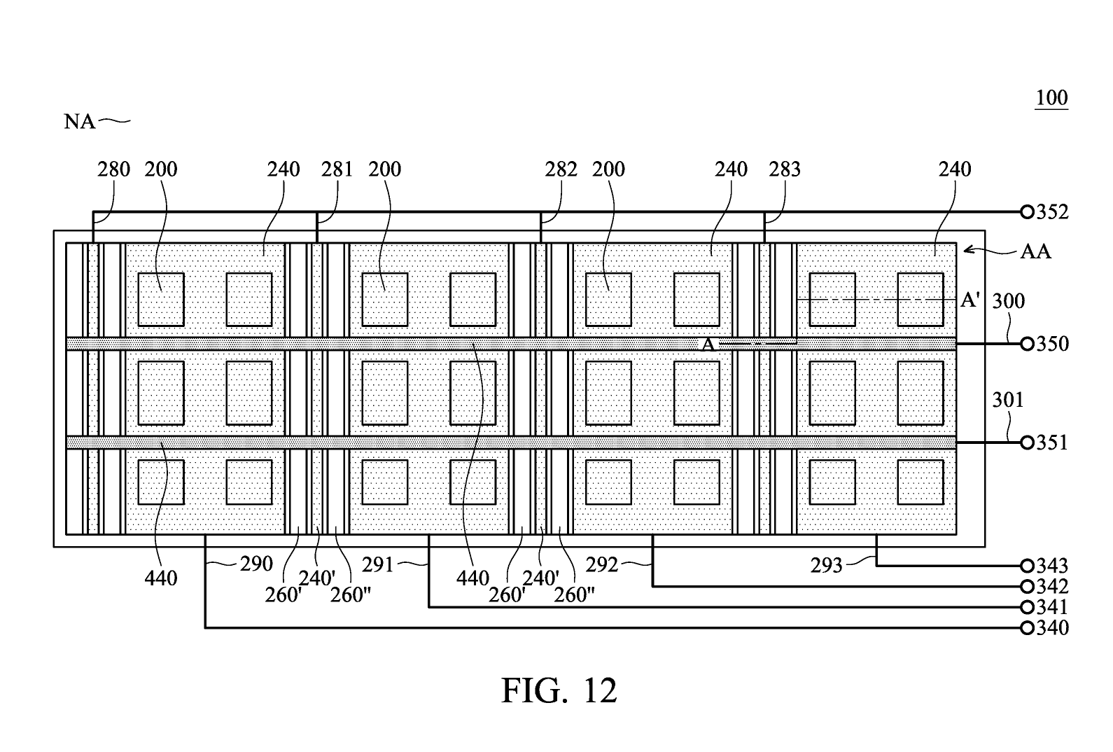

Referring to FIGS. 12 and 10B, in accordance with one embodiment of the disclosure, a touch display device 100 is provided. FIG. 12 is a top view of the touch display device 100. FIG. 10B is a cross-sectional view of the touch display device 100 taken along A-A′ line of FIG. 12.

As shown in FIG. 12, the touch display device 100 is a mutual-capacitance touch display device.

The touch display device 100 comprises a substrate 160; a first electrode 190 disposed on the substrate 160; a first insulating layer 180 comprising an opening 220 disposed on the first electrode 190; a light emitting layer 200 disposed on the first electrode 190; a conductive unit 170 comprising a second electrode 240 and a third electrode 240′ disposed on the first insulating layer 180; a second insulating layer 420 disposed on the conductive unit 170; a fourth electrode 440 disposed on the second insulating layer 420; a first wire (290, 291, 292, 293) electrically connects to the second electrode 240; and a second wire (300, 301) electrically connects to the fourth electrode 440; and a third wire (280, 281, 282, 283) electrically connects to the third electrode 240′. The substrate 160 comprises a display area AA and a non-display area NA adjacent to the display area AA. The second electrode 240 above the first insulating layer 180 electrically connects to the light emitting layer 200 and the first electrode 190 through the opening 220. The second electrode 240 is electrically isolated from the third electrode 240′. The second electrode 240 electrically connects to a first signal source (340, 341, 342, 343) through the first wire (290, 291, 292, 293). The fourth electrode 440 electrically connects to a second signal source (350, 351) through the second wire (300, 301). The third electrode 240′ electrically connects to a third signal source 352 through the third wire (280, 281, 282, 283). In some embodiments, the first electrode 190 may be used as an anode underneath the light emitting layer 200. Specifically, the second electrode 240 may be used as a cathode and a touch electrode.

In this embodiment, the third wire (280, 281, 282 and 283) electrically connects to the third electrode 240′ and the signal source 352. The first wire (290, 291, 292 and 293) electrically connects to the second electrode 240 and the signal source (340, 341, 342 and 343). The second wire (300, 301) electrically connects to the fourth electrode 440 and the signal source (350, 351). Specifically, the signal source 352 may provide a grounding signal. The signal source (340, 341, 342 and 343) may drive the cathode and provide a drive signal Tx at different time periods. The signal source (350, 351) may receive a sensing signal Rx. In other embodiments, the signal source (350, 351) may provide a drive signal Tx. The signal source (340, 341, 342 and 343) may drive the cathode and receive a sensing signal Rx at different time periods. In this embodiment, the signal source (352, 340, 341, 342, 343, 350 and 351) may provide a signal for driving the cathode and a drive signal Tx, and may receive a sensing signal Rx, respectively, at the same time period or different time periods. In other embodiments, the third wire (280, 281, 282 and 283) and the ground signal source 352 may be omitted so that the third electrode 240′ located between the isolation layer 260 is floating.

In some embodiments, the touch display device 100 further comprises an isolation layer 260 disposed between the first insulating layer 180 and the second insulating layer 420, and surrounding the light emitting layer 200. The isolation layer 260 is not limited to a continuous and uninterrupted isolation layer which surrounds the light emitting layer 200. The isolation layer 260 may also be split into a plurality of discontinuous isolation layers. In some embodiments, the isolation layer 260 may comprise a single-layer structure or a double-layer structure. In this embodiment, the isolation layer 260 comprises a single-layer structure. The thickness of the isolation layer 260 is greater than the thickness of the second electrode 240. It should be noted that, in this embodiment, the isolation layer 260 comprises two separated portions (260′, 260″), and the third electrode 240′ is disposed between the two separated portions (260′, 260″).

In some embodiments, the second electrode 240 and the third electrode 240′ may be made of, for example, a transparent material such as ITO, IZO, ITZO or IGZO. In some embodiments, the fourth electrode 440 may be made of, for example, a non-transparent material such as metal.

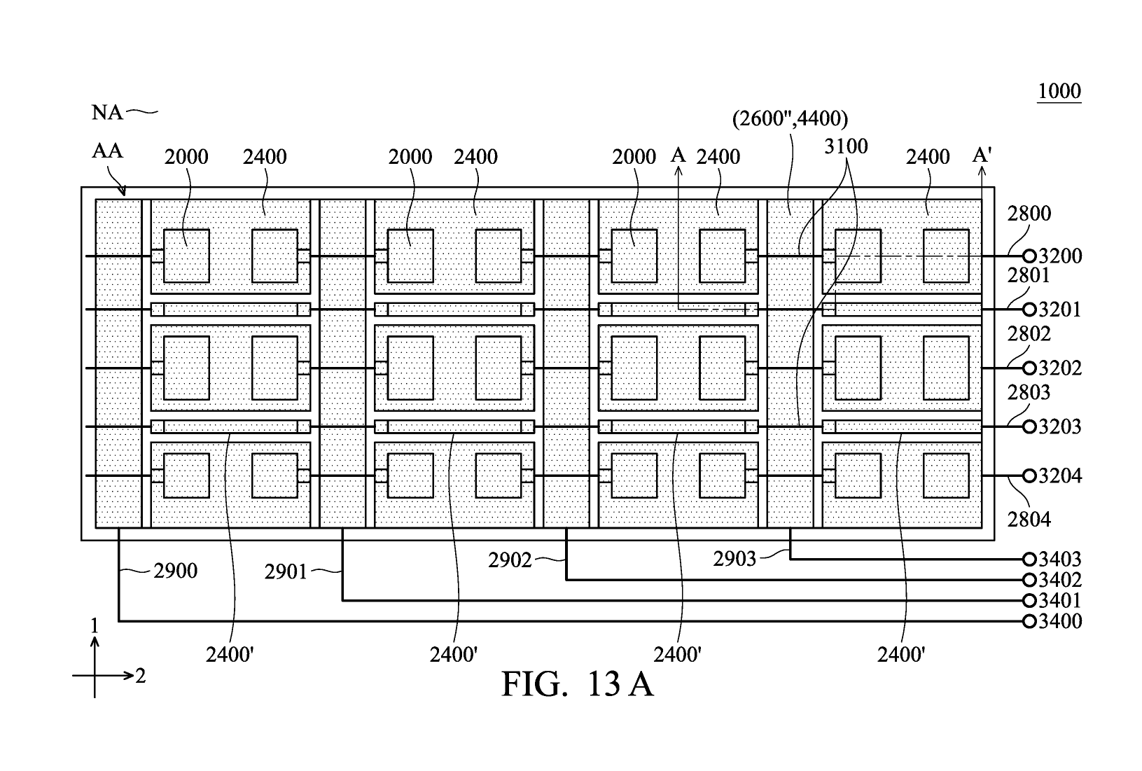

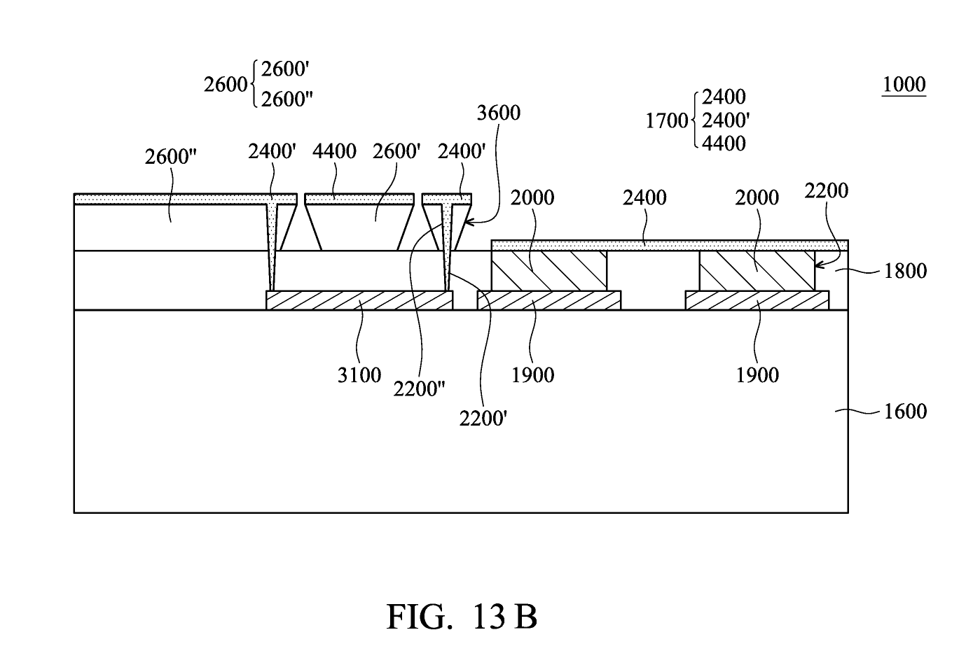

Referring to FIGS. 13A and 13B, in accordance with one embodiment of the disclosure, a touch display device 1000 is provided. FIG. 13A is a top view of the touch display device 1000. FIG. 13B is a cross-sectional view of the touch display device 1000 taken along A-A′ line of FIG. 13A.

As shown in FIG. 13A, the touch display device 1000 is a mutual-capacitance touch display device.

The touch display device 1000 comprises a substrate 1600; a first electrode 1900 disposed on the substrate 1600; a first insulating layer 1800 comprising a first opening 2200 and disposed on the first electrode 1900; a light emitting layer 2000 disposed on the first electrode 1900; an isolation layer 2600 comprising a first portion 2600′ and a second portion 2600″ separated from the first portion 2600′ disposed on the first insulating layer 1800; a conductive unit 1700 comprising a second electrode 2400, a third electrode 2400′ and a fourth electrode 4400; a first wire (2801, 2803) electrically connects to the third electrode 2400′; and a second wire (2900, 2901, 2902, and 2903) electrically connects to the fourth electrode 4400; and a third wire (2800, 2802, 2804) electrically connects to the second electrode 2400. The substrate 1600 comprises a display area AA and a non-display area NA adjacent to the display area AA. The second electrode 2400 is disposed on the first insulating layer 1800. The third electrode 2400′ is disposed on the first portion 2600′ of the isolation layer 2600. The fourth electrode 4400 is disposed on the second portion 2600″ of the isolation layer 2600. The second electrode 2400 electrically connects to the light emitting layer 2000 and the first electrode 1900 through the first opening 2200. The third electrode 2400′ electrically connects to a first signal source (3201, 3203) through the first wire (2801, 2803). The fourth electrode 4400 electrically connects to a second signal source (3400, 3401, 3402, and 3403) through the second wire (2900, 2901, 2902, and 2903). The second electrode 2400 electrically connects to a third signal source (3200, 3202, 3204) through the third wire (2800, 2802, 2804). In some embodiments, the first electrode 1900 may be used as an anode underneath the light emitting layer 2000. Specifically, the second electrode 2400 may be used as a cathode. In this embodiment, the second electrode 2400, the third electrode 2400′, and the fourth electrode 4400 are formed in the same step. In other embodiments, the second electrode 2400, the third electrode 2400′, and the fourth electrode 4400 are formed in different steps.

In this embodiment, the third electrode 2400′ is one of a driving electrode and a sensing electrode, and the fourth electrode 4400 is the other one of the driving electrode and the sensing electrode. In other words, the third electrode 2400′ is functioned as one of a driving electrode and a sensing electrode, and the fourth electrode 4400 is functioned as the other one of the driving electrode and the sensing electrode.

In this embodiment, the light emitting layer 2000 comprises plural light emitting units 2000. The second electrode 2400 comprises plural second sub-electrodes 2400. The third electrode 2400′ comprises plural third sub-electrodes 2400′. The fourth electrode 4400 comprises plural fourth sub-electrodes 4400.

In this embodiment, the second sub-electrodes 2400 and the third sub-electrodes 2400′ are alternately arranged in a first direction 1. The second sub-electrodes 2400 and the fourth sub-electrodes 4400 are alternately arranged in a second direction 2.

In this embodiment, the touch display device 1000 further comprises plural connecting wires 3100 disposed on the substrate 1600.

In this embodiment, the plural second sub-electrodes 2400 electrically connect each other through plural connecting wires 3100.

In this embodiment, the plural third sub-electrodes 2400′ electrically connect each other through plural connecting wires 3100.

In this embodiment, the first insulating layer 1800 comprises plural second openings 2200′.

In this embodiment, the isolation layer 2600 comprises plural third openings 2200″. The plural third sub-electrodes 2400′ electrically connect the plural connecting wires 3100 through the plural second openings 2200′ and the plural third openings 2200″.

In other embodiments, the connecting wire 3100 is in the first insulating layer 1800 and is formed simultaneously with the first electrode 1900.

In this embodiment, the third wire (2800, 2802 and 2804) electrically connects to the second electrode 2400 and the signal source (3200, 3202 and 3204). The first wire (2801, 2803) electrically connects to the third electrode 2400′ and the signal source (3201, 3203). The second wire (2900, 2901, 2902 and 2903) electrically connects to the fourth electrode 4400 and the signal source (3400, 3401, 3402 and 3403). Specifically, the signal source (3200, 3202 and 3204) may provide a signal to drive the cathode. The signal source (3201, 3203) may provide a drive signal Tx. The signal source (3400, 3401, 3402 and 3403) may receive a sensing signal Rx. In other embodiments, the signal source (3400, 3401, 3402 and 3403) may provide a drive signal Tx. The signal source (3201, 3203) may receive a sensing signal Rx. In this embodiment, the signal source (3200, 3201, 3202, 3203, 3204, 3400, 3401, 3402, and 3403) may provide a signal for driving the cathode and a drive signal Tx, and may receive a sensing signal Rx, respectively, at the same time period or different time periods.

In some embodiments, the isolation layer 2600 may comprise a single-layer structure or a double-layer structure. In this embodiment, the isolation layer 2600 comprises a single-layer structure. By adjusting the parameters of the process, the etching degree of the lower portion is greater than the etching degree of the higher portion of the isolation layer 2600, such that the isolation layer 2600 with an inclined sidewall 3600 is formed. Specifically, an inclined angle of the inclined sidewall 3600 of the isolation layer 2600 is greater than 90 degrees. In some embodiments, the isolation layer 2600 has an inclined sidewall which shrinks inwardly from the top to the bottom thereof.

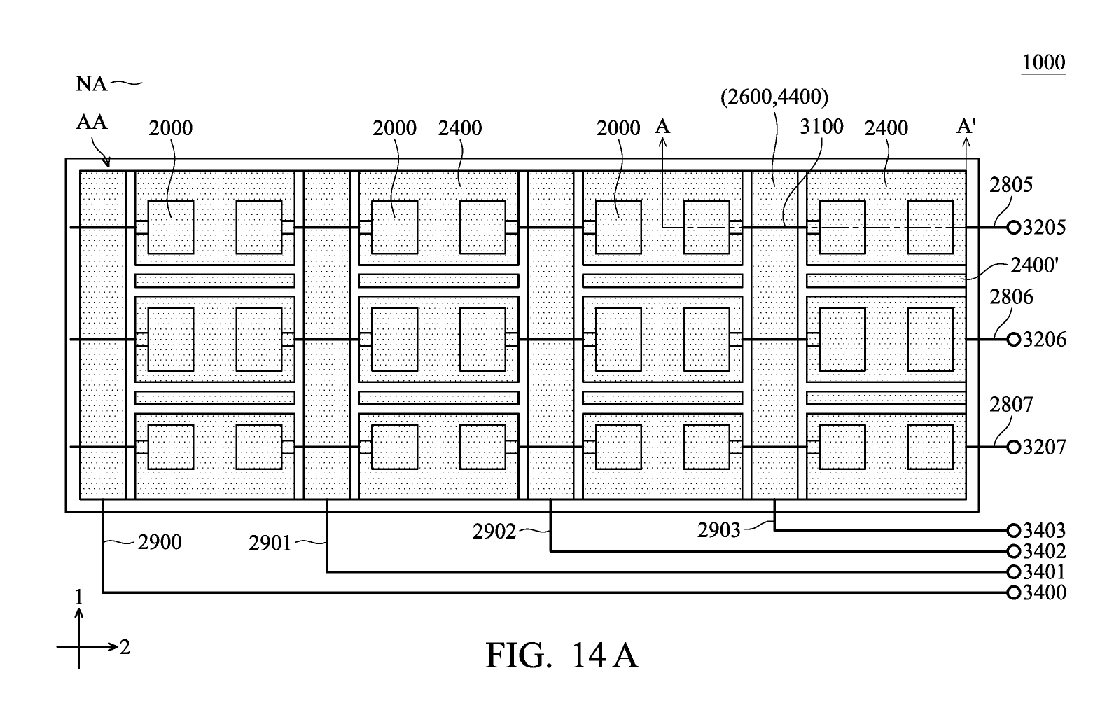

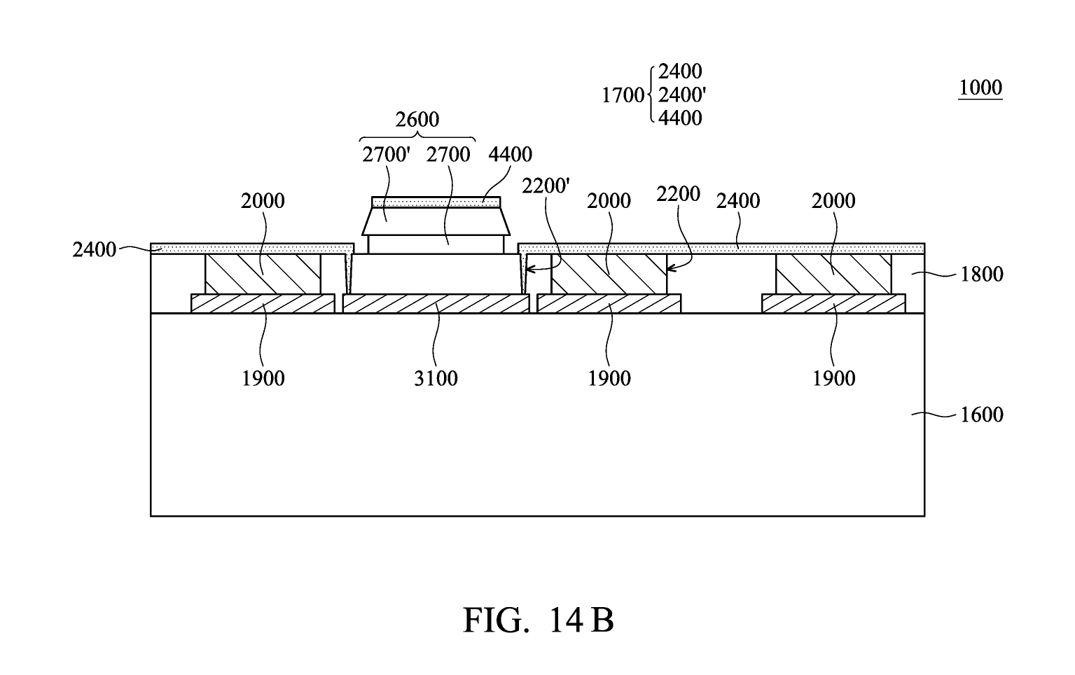

Referring to FIGS. 14A and 14B, in accordance with one embodiment of the disclosure, a touch display device 1000 is provided. FIG. 14A is a top view of the touch display device 1000. FIG. 14B is a cross-sectional view of the touch display device 1000 taken along A-A′ line of FIG. 14A.

As shown in FIG. 14A, the touch display device 1000 is a mutual-capacitance touch display device.

The touch display device 1000 comprises a substrate 1600; a first electrode 1900 disposed on the substrate 1600; a first insulating layer 1800 comprising a first opening 2200 disposed on the first electrode 1900; a light emitting layer 2000 disposed on the first electrode 1900; an isolation layer 2600 disposed on the first insulating layer 1800; a conductive unit 1700 comprising a second electrode 2400, a third electrode 2400′ and a fourth electrode 4400; a first wire (2805, 2806, and 2807) electrically connects to the second electrode 2400; and a second wire (2900, 2901, 2902, and 2903) electrically connects to the fourth electrode 4400. The substrate 1600 comprises a display area AA and a non-display area NA adjacent to the display area AA. The second electrode 2400 is disposed on the first insulating layer 1800. The fourth electrode 4400 is disposed on the isolation layer 2600. The second electrode 2400 electrically connects to the light emitting layer 2000 and the first electrode 1900 through the first opening 2200. The second electrode 2400 electrically connects to a first signal source (3205, 3206, and 3207) through the first wire (2805, 2806, and 2807). The fourth electrode 4400 electrically connects to a second signal source (3400, 3401, 3402, and 3403) through the second wire (2900, 2901, 2902, and 2903). In some embodiments, the first electrode 1900 may be used as an anode underneath the light emitting layer 2000. Specifically, the second electrode 2400 may be used as a cathode and a touch electrode at different time periods. In this embodiment, the second electrode 2400, the third electrode 2400′, and the fourth electrode 4400 are formed in the same step. In other embodiments, the second electrode 2400, the third electrode 2400′, and the fourth electrode 4400 are formed in different steps.

In this embodiment, the second electrode 2400 is one of a driving electrode and a sensing electrode, and the fourth electrode 4400 is the other one of the driving electrode and the sensing electrode. In other words, the second electrode 2400 is functioned as one of a driving electrode and a sensing electrode, and the fourth electrode 4400 is functioned as the other one of the driving electrode and the sensing electrode.

In this embodiment, the light emitting layer 2000 comprises plural light emitting units 2000. The second electrode 2400 comprises plural second sub-electrodes 2400. The third electrode 2400′ comprises plural third sub-electrodes 2400′. The fourth electrode 4400 comprises plural fourth sub-electrodes 4400.

In this embodiment, the second sub-electrodes 2400 and the third sub-electrodes 2400′ are alternately arranged in a first direction 1. The third sub-electrodes 2400′ and the fourth sub-electrodes 4400 are alternately arranged in a second direction 2.

In this embodiment, the touch display device 1000 further comprises plural connecting wires 3100 disposed on the substrate 1600. The plural second sub-electrodes 2400 electrically connect each other through the plural connecting wires 3100.

In this embodiment, the first insulating layer 1800 comprises plural second openings 2200′. The plural second sub-electrodes 2400 electrically connect the plural connecting wires 3100 through the plural second openings 2200′.

In this embodiment, the connecting wire 3100 is in the first insulating layer 1800 and is formed simultaneously with the first electrode 1900. But the disclosure is not limited thereto.

In this embodiment, the first wire (2805, 2806 and 2807) electrically connects to the second electrode 2400 and the first signal source (3205, 3206 and 3207). The second wire (2900, 2901, 2902 and 2903) electrically connects to the fourth electrode 4400 and the second signal source (3400, 3401, 3402 and 3403). Specifically, the first signal source (3205, 3206 and 3207) may provide a signal to drive the cathode and a drive signal Tx, respectively, at different time periods. The second signal source (3400, 3401, 3402, and 3403) may receive a sensing signal Rx. In other embodiments, the second signal source (3400, 3401, 3402, and 3403) may provide a drive signal Tx. The first signal source (3205, 3206 and 3207) may receive a sensing signal Rx.

In some embodiments, the isolation layer 2600 may comprise a single-layer structure or a double-layer structure. In this embodiment, the isolation layer 2600 comprises the double-layer structure (for example, a lower layer 2700 and an upper layer 2700′). It should be noted that the layers of the isolation layer 2600 constituted by the double-layer structure (e.g., the lower layer 2700 and the upper layer 2700′) have different degrees of etching, for example, the etching degree of the lower layer 2700 is greater than the etching degree of the upper layer 2700′, such that the isolation layer 2600 has an inwardly depressed sidewall, or a T like-type structure. It should be noted that the thickness of the lower layer 2700 is greater than the thickness of the second electrode 2400.

The touch display device provided by the present disclosure is suitable for use in quantum dot light emitting diodes (QLEDs), organic light emitting diode (OLED), or inorganic light emitting diodes.

It will be apparent to those skilled in the art that various modifications and variations can be made to the disclosed embodiments. It is intended that the specification and examples be considered as exemplary only, with the true scope of the disclosure being indicated by the following claims and their equivalents.

What is claimed is:

1. A touch display device, comprising:
a substrate comprising a display area and a non-display area, wherein the non-display area is adjacent to the display area;
a conductive unit disposed on the substrate, wherein the conductive unit comprises a first electrode and a wire;
a first insulating layer disposed on the conductive unit, wherein the first insulating layer comprises a first opening and a second opening;
a light emitting layer disposed on the first electrode; and
a second electrode disposed on the first insulating layer, wherein the second electrode electrically connects to the light emitting layer and the first electrode through the first opening and electrically connects to the wire through the second opening,
wherein the wire extends from the display area to the non-display area and electrically connects to a signal source.

2. The touch display device as claimed in claim 1, further comprising an isolation layer disposed on the first insulating layer.

3. The touch display device as claimed in claim 2, wherein the isolation layer is a single-layer structure or a double-layer structure.

4. The touch display device as claimed in claim 3, wherein the single-layer structure has an inclined sidewall which shrinks inwardly from the top to the bottom thereof.

5. The touch display device as claimed in claim 3, wherein the double-layer structure is a T like-type structure.

6. The touch display device as claimed in claim 2, further comprising a third electrode disposed on the isolation layer, wherein the third electrode is a grounding electrode.

7. A touch display device, comprising:
a substrate;
a first electrode disposed on the substrate;
a first insulating layer disposed on the first electrode, wherein the first insulating layer comprises an opening;
a light emitting layer disposed on the first electrode;
a conductive unit disposed on the first insulating layer, wherein the conductive unit comprises a second electrode and a third electrode, wherein the second electrode electrically connects to the light emitting layer and the first electrode through the opening, and the second electrode is electrically isolated from the third electrode;
a second insulating layer disposed on the conductive unit;
a fourth electrode disposed on the second insulating layer;
a first wire electrically connected to the second electrode or the third electrode; and
a second wire electrically connected to the fourth electrode,
wherein the second electrode or the third electrode electrically connects to a first signal source through the first wire, and the fourth electrode electrically connects to a second signal source through the second wire.

8. The touch display device as claimed in claim 7, further comprising an isolation layer disposed between the first insulating layer and the second insulating layer, and the third electrode is disposed on the isolation layer.

9. The touch display device as claimed in claim 8, wherein the isolation layer is a single-layer structure or a double-layer structure.

10. The touch display device as claimed in claim 9, wherein the single-layer structure has an inclined sidewall which shrinks inwardly from the top to the bottom thereof.

11. The touch display device as claimed in claim 9, wherein the double-layer structure is a T like-type structure.

12. The touch display device as claimed in claim 7, further comprising an isolation layer disposed between the first insulating layer and the second insulating layer, the isolation layer comprises two separated portions, and the third electrode is disposed between the two separated portions.

13. A touch display device, comprising:
a substrate;
a first electrode disposed on the substrate;
a first insulating layer disposed on the first electrode, wherein the first insulating layer comprises a first opening;
a light emitting layer disposed on the first electrode;
an isolation layer disposed on the first insulating layer, wherein the isolation layer comprises a first portion and a second portion, and the first portion is separated from the second portion;
a conductive unit comprising a second electrode, a third electrode and a fourth electrode, wherein the second electrode is disposed on the first insulating layer, the third electrode is disposed on the first portion, and the fourth electrode is disposed on the second portion, wherein the second electrode electrically connects to the light emitting layer and the first electrode through the first opening;
a first wire electrically connected to the second electrode or the third electrode; and
a second wire electrically connected to the fourth electrode,
wherein the second electrode or the third electrode electrically connects to a first signal source through the first wire, the fourth electrode electrically connects to a second signal source through the second wire.

14. The touch display device as claimed in claim 13, wherein the second electrode or the third electrode is functioned as one of a driving electrode and a sensing electrode, and the fourth electrode is functioned as the other one of the driving electrode and the sensing electrode.

15. The touch display device as claimed in claim 13, wherein the second electrode comprises plural second sub-electrodes, the third electrode comprises plural third sub-electrodes, the third electrode comprises plural fourth sub-electrodes, wherein the second sub-electrodes and the third sub-electrodes are alternately arranged in a first direction, and the second sub-electrodes and the fourth sub-electrodes are alternately arranged in a second direction.

16. The touch display device as claimed in claim 13, further comprising plural connecting wires disposed on the substrate, wherein the plural second sub-electrodes electrically connect each other through the plural connecting wires.

17. The touch display device as claimed in claim 16, wherein the first insulating layer comprises plural second openings, and the plural second sub-electrodes electrically connect to the plural connecting wires through the plural second openings.

18. The touch display device as claimed in claim 13, further comprising plural connecting wires disposed on the substrate, wherein the plural third sub-electrodes electrically connect each other through the connecting wires.

19. The touch display device as claimed in claim 18, wherein the first insulating layer comprises plural second openings, the isolation layer comprises plural third openings, and the plural third sub-electrodes electrically connect to the plural connecting wires through the plural second openings and the plural third openings.
